(19) United States
(12) Patent Application Publication
(10) Pub. No.: US 2025/0081280 A1
(43) Pub. Date: Mar. 6, 2025

(54) MANAGING MEASUREMENT IN SMALL DATA TRANSMISSION

(71) Applicant: GOOGLE LLC, Mountain View, CA (US)

(72) Inventor: Chih-Hsiang Wu, Taoyuan City (TW)

(21) Appl. No.: 18/727,528

(22) PCT Filed: Jan. 10, 2023
(86) PCT No.: PCT/US2023/010443

§ 371 Date: Jul. 9, 2024

Related U.S. Application Data
(60) Provisional application No. 63/355,918, filed on Jun. 27, 2022.
(60) Provisional application No. 63/298,195, filed on Jan. 10, 2022.

(51) Int. Cl. H04W 76/27

(52) U.S. Cl. CPC H04W 76/27

(57) ABSTRACT

One or more nodes of a radio access network (RAN) perform a method of configuring or reconfiguring a user equipment (UE). The method includes communicating (802) data with the UE while the UE is in an inactive state and configured for small data transmission (SDT) operation, and determining (804) to configure or reconfigure one or more radio resources for the UE while the UE is in the inactive state and configured for SDT operation. The method also includes, transmitting (810), in response to the determining and while the UE is in the inactive state and configured for SDT operation, a message to the UE to configure or reconfigure the one or more radio resources for the UE.

### FIELD OF THE DISCLOSURE

This disclosure relates generally to wireless communications and, more particularly, to managing measurement and reporting for a user equipment (UE) and a radio access network (RAN), e.g., when the UE operates in an inactive or idle state associated with a protocol for controlling radio resources and communicates uplink and/or downlink data with the RAN.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally, a base station operating in a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer.

The RRC sublayer specifies the RRC_IDLE state, in which a UE does not have an active radio connection with a base station; the RRC_CONNECTED state, in which the UE has an active radio connection with the base station; and the RRC_INACTIVE to allow a UE to more quickly transition back to the RRC_CONNECTED state using RAN-level base station coordination and RAN-paging procedures. In some cases, the UE in the RRC_INACTIVE state has only one, relatively small packet to transmit. For situations such as these, 3GPP is discussing a Small Data Transmission (SDT) procedure to enable the 5G NR to support data transmission for the UE operating the RRC_INACTIVE state (i.e., without requiring that the UE transition to the RRC_CONNECTED state).

SDT is enabled on a radio bearer basis and is initiated by the UE, only if less than a configured amount of uplink data awaits transmission across all radio bearers for which SDT is enabled, the downlink (DL) reference signal received power (RSRP) is above a configured threshold, and a valid SDT resource is available. An SDT procedure can be initiated by the UE with either a transmission over a random access channel (RACH), i.e., random access SDT (RA-SDT), or over Type 1 configured grant (CG) resources, i.e., CG-SDT. For the RA-SDT, the network configures 2-step and/or 4-step random access resources for SDT. In the RA-SDT, the UE can transmit an initial transmission including data in a message 3 (MSG3) of a 4-step random access procedure or in the payload of a message A (MSGA) of a 2-step random access procedure. The network can then schedule subsequent uplink and/or downlink transmissions for the UE using dynamic uplink grants and downlink assignments, respectively, after completion of the random access procedure.

The CG-SDT can only be initiated with a valid uplink (UL) timing alignment. The UE maintains the UL timing alignment based on a network configured, SDT-specific timing alignment timer and the DL RSRP of a configured number of highest ranked SSBs. Upon expiry of the SDT-specific timing alignment timer, the CG resources are released. Upon initiating the CG-SDT, the UE transmits an initial transmission including data on a CG occasion using a CG configuration, and the network can schedule subsequent UL transmissions using dynamic grants or on future CG resource occasions. During the CG-SDT, the DL transmissions are scheduled using dynamic assignments. The UE can initiate subsequent UL transmission only after receiving, from the network, confirmation of the initial UL transmission.

As described in 3GPP specification 38.300 v16.8.0 section 9.2.4, the UE performs measurements and transmits measurement reports to the NG-RAN while the UE operates in the RRC_CONNECTED state. However, it is not clear whether or how UE measurement configuration and measurement reporting procedures relate to the RRC_INACTIVE state of the UE, particularly when SDT is enabled for the UE.

When a UE in the RRC_INACTIVE state has an SDT session with an NG-RAN on a first cell, the first cell may become unsuitable for communication between RAN and the UE. In such cases, the UE triggers cell selection or reselection during the SDT session. Therefore, the UE selects or reselects a second cell to camp on without receiving an RRC release message from the NG-RAN. The UE aborts the SDT session with the NG-RAN due to the cell selection or reselection from the first cell to the second cell. When the UE aborts the SDT session, the UE in the RRC_INACTIVE state transitions to the RRC_IDLE state. After transitioning to the RRC_IDLE state and (re)selecting the second cell, the UE must transition to the connected state in order to again communicate data with the NG-RAN. In particular, the UE in the RRC_IDLE state performs an RRC connection establishment procedure to transition to the connected state, and performs other RRC procedures such as a security mode activation procedure and RRC reconfiguration procedures to activate security and obtain SRB2 and DRB configurations, even if the UE or the NG-RAN has only a small amount of data (“small data”) to communicate with (i.e., transmit to and/or receive from) the RAN. However, transitioning to the connected state merely to communicate small data is very inefficient.

### SUMMARY

According to certain techniques of this disclosure, a UE performs measurement reporting to a RAN when the UE is in a connected state, but refrains from transmitting any measurement reports corresponding to times or time periods when the UE is in an inactive state with SDT enabled. The UE may avoid measurement reporting in the latter state by continuing to evaluate whether measurements trigger a reporting event (i.e., satisfy one or more conditions), but disabling reporting such that the UE does not send a report to the RAN when a reporting event is triggered. Alternatively, the UE may avoid measurement reporting by refraining from using the measurements to evaluate whether the measurements trigger a reporting event.

In another technique of this disclosure, if the RAN determines to configure or reconfigure one or more radio resources for the UE while the UE is in an inactive state with SDT enabled, the RAN sends the inactive UE a message to configure or reconfigure the radio resources for the UE. The message may be an RRC resume message or an RRC release message, for example.

Other techniques of this disclosure relate more specifically to the management and/or use of measurement configurations. In some implementations, one or more nodes of a RAN (e.g., a base station of the RAN, or a central unit (CU) and distributed unit (DU) of such a base station) sends a UE one or more measurement configurations while the UE is in a connected state, and at some later time determines to transition the UE to an inactive state. Thereafter, the RAN causes the UE to release the at least one measurement configuration, and to transition to the inactive state. For example, the RAN may send the UE an RRC reconfiguration message while the UE is still in the connected state to cause the UE to release the measurement configuration(s), and subsequently send the UE an RRC release message to cause the UE to transition to the inactive state. In some implementations, the RAN causes the UE to release the measurement configuration(s) (e.g., by sending the UE an RRC reconfiguration message) specifically in response to determining to enable SDT for the UE.

In some implementations, where the RAN configures the UE with a measurement configuration that specifies a measurement gap, the UE uses the measurement gap (e.g., to perform carrier frequency measurements or send reference signals to the RAN) when the UE is in the connected state, but refrains from using the measurement gap when the UE is in the inactive state with SDT enabled. Additionally or alternatively, the RAN may refrain from transmitting a downlink control information (DCI) (e.g., with a cyclic redundancy check (CRC) scrambled with a radio network temporary identifier (RNTI) of the UE) to the UE during the measurement gap when the UE is in the connected state (e.g., while the UE is using the measurement gap to perform measurements or send reference signals), but sends the DCI (e.g., with scrambled CRC) to the UE irrespective of the measurement gap when the UE is in the inactive state with SDT enabled (i.e., while the UE is not using the measurement gap to perform measurements or send reference signals).

In still other techniques of this disclosure, the UE can perform measurement reporting while in the inactive state with SDT enabled. Based on the contents of this measurement reporting, the RAN may send an RRC release message to the UE (to allow the UE to begin communicating with the RAN via a different cell, without first transitioning to the connected state), transmit an RRC resume message to the UE (to transition the UE to the connected state), or continue to communicate data with the RAN via the same cell and SDT. In some implementations, the RAN may perform measurements for the UE while the UE is in the inactive state with SDT enabled, in addition to or instead of receiving measurement reports from the inactive UE.

As used herein, and unless a more specific meaning is clear from the context of use, the term “data” or “data packet” can refer to signaling, control-plane information at a protocol layer of controlling radio resources (e.g., RRC), controlling mobility management (MM), or controlling session management (SM), or can refer to non-signaling, non-control-plane information at a protocol layer above the layer of the protocol for controlling radio resources (e.g., RRC), above the layer of the protocol for controlling MM, above the layer of the protocol for controlling SM, and/or above the layer of the protocol for controlling quality of service (QoS) flows (e.g., service data adaptation protocol (SDAP)). The data to which the UE and/or the RAN applies the techniques of this disclosure can include, for example, Internet of things (IoT) data, Ethernet traffic data, Internet traffic data, or a short message service (SMS) message, for example. Further, the UE in some implementations applies SDT techniques only if the size of the data is below a certain (e.g., configured) threshold value. It is also understood that, as used herein (and unless the context of its use indicates a more specific meaning), the term “configuration” can refer to a full configuration, or to a subset of parameters of a full configuration (e.g., a “delta” or other partial configuration that can augment an existing configuration without completely replacing the existing configuration).

In some examples, one or more nodes of a RAN perform a method of configuring or reconfiguring a UE. The method includes communicating data with the UE while the UE is in an inactive state and configured for SDT operation, and determining to configure or reconfigure one or more radio resources for the UE while the UE is in the inactive state and configured for SDT operation. The method also includes, in response to the determining, transmitting, while the UE is in the inactive state and configured for SDT operation, a message to the UE to configure or reconfigure the one or more radio resources for the UE.

In other examples, a UE performs a method of managing measurement reporting. The method includes performing a plurality of measurements on a carrier frequency used for communication with a RAN. The plurality of measurements include (i) first measurements corresponding to times when the UE is in a connected state, and (ii) second measurements corresponding to times when the UE is in an inactive state and configured for SDT operation. The method also includes transmitting a first measurement report based on at least one of the first measurements to the RAN, and refraining from transmitting any measurement report based on the second measurements.

### BRIEF DESCRIPTION OF THE DRAWINGS

FIG. 1A is a block diagram of an example wireless communication system in which a radio access network (RAN) and/or a user equipment (UE) can implement the techniques of this disclosure;

FIG. 1B is a block diagram of an example base station, including a central unit (CU) and a distributed unit (DU), that can operate in the RAN of FIG. 1A;

FIG. 2A is a block diagram of an example protocol stack according to which the UE of FIG. 1A can communicate with the RAN of FIG. 1A;

FIG. 2B is a block diagram of an example protocol stack according to which the UE of FIG. 1A can communicate with a DU and a CU of a base station of FIG. 1A or 1B;

FIG. 3A is an example message sequence in which a UE in an inactive state transmits measurement results obtained on one or more carrier frequencies during small data communication with a RAN, and receives from the RAN a downlink (DL) radio resource control (RRC) message that causes the UE to stop the small data communication;

FIG. 3B is an example message sequence in which a UE in an inactive state transmits measurement results obtained on one or more carrier frequencies during small data communication with a RAN, and receives from the RAN a DL RRC message that causes the UE to transition to a connected state;

FIG. 4A is a flow diagram of an example method for determining to stop a SDT session with a UE, based on one or more measurement results for the UE, which can be implemented in the RAN of FIG. 1A, or the CU (e.g., CU-CP) of FIG. 1B;

FIG. 4B is a flow diagram of an example method for determining to change a SDT session with a UE to a non-SDT session, based on one or more measurement results for the UE, which can be implemented in the RAN of FIG. 1A, or the CU (e.g., CU-CP) of FIG. 1B;

FIG. 5 is a flow diagram of an example method for determining whether to communicate with a UE in an inactive state or a connected state, which can be implemented in the RAN of FIG. 1A, or the CU (e.g., CU-CP) of FIG. 1B;

FIG. 6 is a flow diagram of an example method for determining to process or ignore a measurement result received from a UE, which can be implemented in the RAN of FIG. 1A, or the CU (e.g., CU-CP) of FIG. 1B;

FIGS. 7A-7B are flow diagrams of example methods for managing a measurement configuration for a UE when determining to transition the UE to the inactive state, which can be implemented in the RAN of FIG. 1A, or the CU (e.g., CU-CP) of FIG. 1B;

FIG. 8 is a flow diagram of an example method for determining how to reconfigure radio resources for a UE depending on whether the UE is operating in a connected state, which can be implemented in the RAN of FIG. 1A, or the CU (e.g., CU-CP) of FIG. 1B;

FIG. 9 is a flow diagram of an example method in which a UE transmits a measurement report to a RAN while communicating data with the RAN in the inactive state, which can be implemented in the UE of FIG. 1A;

FIG. 10 is a flow diagram of an example method in which a UE determines whether to transmit a measurement report to a RAN while communicating data with the RAN in the inactive state, which can be implemented in the UE of FIG. 1A;

FIG. 11 is a flow diagram of an example method in which a UE determines whether to evaluate a reporting event configured by a RAN while operating in an inactive state, which can be implemented in the UE of FIG. 1A;

FIG. 12 is a flow diagram of an example method in which a UE determines whether to evaluate a reporting event configured by a RAN while operating in a connected state or an inactive state, which can be implemented in the UE of FIG. 1A;

FIG. 13 is a flow diagram of an example method in which a UE determines whether to use or apply a measurement gap configuration configured by a RAN while operating in a connected state or an inactive state, which can be implemented in the UE of FIG. 1A;

FIG. 14 is a flow diagram of an example method for determining whether to use or apply a measurement gap configuration for a UE, depending on whether the UE operates in a connected state or an inactive state, which can be implemented in the RAN of FIG. 1A, or the CU (e.g., CU-CP) of FIG. 1B;

### DETAILED DESCRIPTION OF THE DRAWINGS

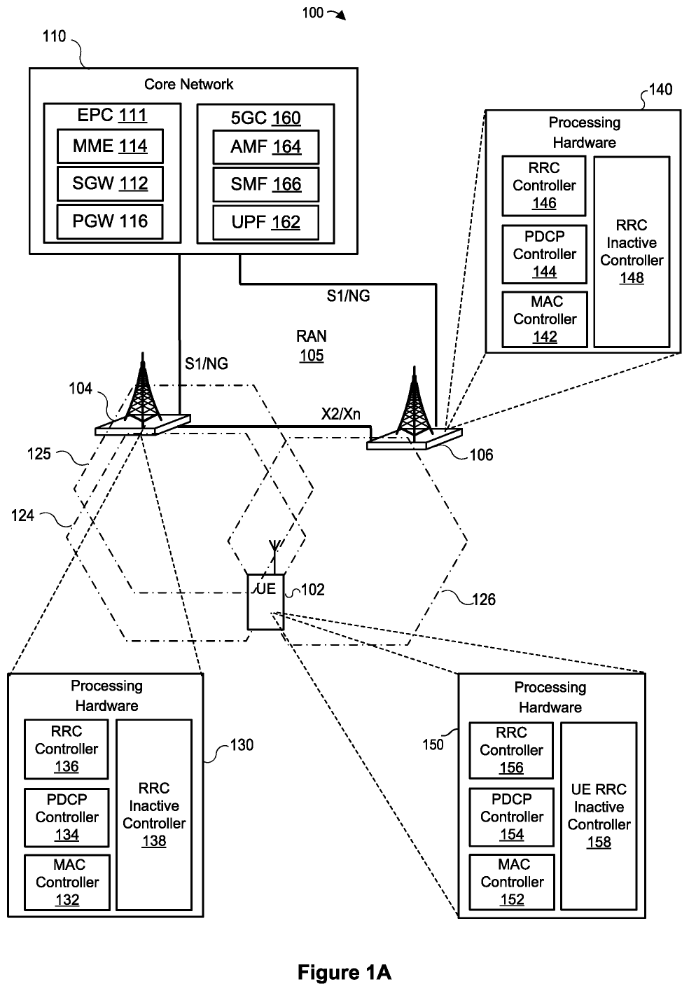

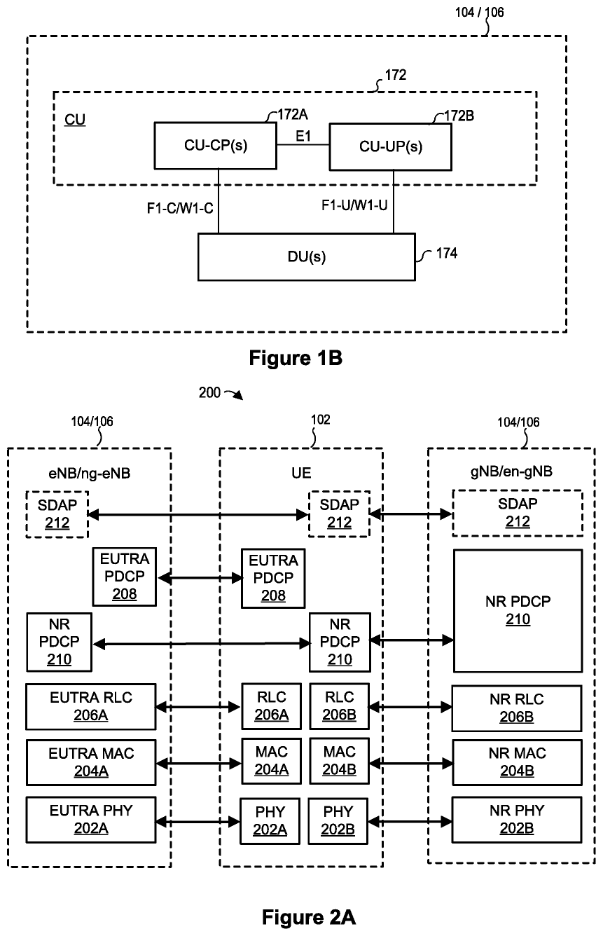

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core in another example.

The base station 104 can cover one or more cells (e.g., cells 124 and 125), and the base station 106 can similarly cover one or more cells (e.g., cell 126). If the base station 104 is a gNB, the cells 124 and 125 are NR cells. If the base station 104 is an (ng-)eNB, the cells 124, 125 are evolved universal terrestrial radio access (EUTRA) cells. Similarly, if the base station 106 is a gNB, the cell 126 is an NR cell, and if the base station 106 is an (ng-)eNB, the cell 126 is an EUTRA cell. The cells 124, 125, and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or EUTRA air interface to communicate with the base stations 104, 106. Each of the base stations 104, 106 can connect to the CN 110 via an interface (e.g., S1 or NG interface). The base stations 104, 106 also can be interconnected with each other via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE 102 to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports cells 124 and 125, and the base station 106 supports a cell 126. The cells 124, 125, and 126 can partially overlap, so that the UE 102 can select, reselect, or hand over from one of the cells 124, 125, and 126 to another. To directly exchange messages or information, the base station 104 and base station 106 can support an X2 or Xn interface. In general, the CN 110 can connect to any suitable number of base stations supporting NR cells and/or EUTRA cells.

As discussed in detail below, the UE 102 can implement the techniques of this disclosure for measuring a carrier frequency, as instructed by the RAN 105, without interrupting data communication when the radio connection between the UE 102 and the RAN 105 is suspended, e.g., in the inactive or idle state of the protocol for controlling radio resources between the UE 102 and the RAN 105. For clarity, the examples below refer to the RRC_INACTIVE or RRC_IDLE state of the RRC protocol. As discussed below, the UE 102 in some implementations applies the techniques of this disclosure only if the size of the data (e.g., UL data) is below a certain threshold value.

In the example scenarios discussed below, the UE 102 transitions to the RRC_INACTIVE or RRC_IDLE state, selects a cell of the base station 104, and exchanges data with the base station 104 either via the base station 106 or with the base station 104 directly, without transitioning to the RRC_CONNECTED state. After the UE 102 determines that data is available for UL transmission in the RRC_INACTIVE or RRC_IDLE state, the UE 102 can generally secure the data, include the secured data as a security-protected packet in a first UL PDU, and transmit the first UL PDU to the RAN 105 in a second UL PDU.

As a more specific example, the UE 102 can apply one or more security functions to secure-protect the UL data packet, generate a first UL PDU that includes the security-protected UL data packet, include a UL RRC message along with the first UL PDU in a second UL PDU, and transmit the second UL PDU to the RAN 105. After receiving the second UL PDU, the RAN 105 can identify the UE 102 based on a UE identity/identifier (ID) of the UE 102 included in the UL RRC message. In some implementations, the UE ID can be an inactive Radio Network Temporary Identifier (I-RNTI), a resume ID, or a non-access stratum (NAS) ID. The NAS ID can be an S-Temporary Mobile Subscriber Identity (S-TMSI) or a Global Unique Temporary Identifier (GUTI), in some implementations.

In some implementations, the security function that the UE 102 applied to the UL data packet as discussed above can include an integrity protection and/or encryption function. In applying integrity protection, the UE 102 can generate a message authentication code for integrity (MAC-I) to protect integrity of the data. Thus, the UE 102 in this case generates a security-protected packet that includes the data and the MAC-I. In applying an encryption function, the UE 102 can encrypt the data to obtain an encrypted packet, so that the security-protected packet includes encrypted data. When both integrity protection and encryption are applied, the UE 102 can generate a MAC-I for protecting integrity of the data and encrypt the data along with the MAC-I to generate an encrypted packet and an encrypted MAC-I. The UE 102 then can transmit the security-protected packet to the RAN 105, while still in the RRC_INACTIVE or RRC_IDLE state.

In some implementations, the data described above is a UL service data unit (SDU) of the packet data convergence protocol (PDCP) or SDAP. The UE 102 applies the security function to the SDU and includes the secured SDU in a first UL PDU (e.g., a UL PDCP PDU). The UE 102 then includes the UL PDCP PDU in a second UL PDU such as a UL MAC PDU, which can be associated with the MAC layer. Thus, the UE 102 in these cases transmits the secured UL PDCP PDU in the UL MAC PDU. In some implementations, the UE 102 can include, in the UL MAC PDU, a UL RRC message. In other implementations, the UE 102 may omit a UL RRC message from the UL MAC PDU. In this latter case, the UE 102 may omit a UE ID of the UE 102 from the UL MAC PDU. In yet other implementations, the UE 102 can include the UL PDCP PDU in a UL radio link control (RLC) PDU and then include the UL RLC PDU in the UL MAC PDU. In some implementations in which the UE 102 includes the UL RRC message in the UL MAC PDU, the UE 102 generates an RRC MAC-I (e.g., resumeMAC-I field, as specified in 3GPP specification 38.331) and includes the RRC MAC-I in the UL RRC message. In other implementations, rather than generating the RRC MAC-I, the UE 102 can obtain the RRC MAC-I from the UL RRC message with an integrity key (e.g., K_{RRCint} key), an integrity protection algorithm, and parameters such as COUNT (e.g., 32-bit, 64-bit or 128-bit value), BEARER (e.g., 5-bit value), and DIRECTION (e.g., 1-bit value).

In other implementations, the data described above is a UL SDU of the NAS. The UE 102 applies the security function to the SDU and includes the secured SDU in a first UL PDU such as a UL NAS PDU, which can be associated with the NAS layer. For example, the NAS layer can be an MM or SM sublayer of 5G, evolved packet system (EPS), or 6G. Then the UE 102 can include the UL NAS PDU in a second UL PDU such as a UL RRC message. The UE 102 in these cases then transmits the (first) secured UL NAS PDU in the UL RRC message. In some implementations, the UE 102 can include the UL RRC message in a UL MAC PDU and transmits the UL MAC PDU to a base station (e.g., base station 104 or 106) via a cell (e.g., cell 124 or 126). The UE 102 may not include an RRC MAC-I in the UL RRC message, or alternatively, include an RRC MAC-I as described above.

In some implementations, the UL RRC message described above can be a common control channel (CCCH) message, an RRC resume request message, or an RRC early data request message. The RRC resume request message can be an existing RRC resume request message (e.g., an RRCResumeRequest message, an RRCResumeRequest1 message, an RRCConnectionResumeRequest message, or an RRCConnectionResumeRequest1 message), or a new RRC resume request message that is similar to the existing RRC resume request message but defined as a format of a RRC release or version later than that of the existing RRC resume request message. In some implementations, the UL RRC message can include a UE ID of the UE 102 as described above.

In some scenarios and implementations in which the UE ID of the UE 102 is included in the UL RRC message as described above, the base station 106 can retrieve the UE ID of the UE 102 from the UL RRC message and identify, based on the determined UE ID, the base station 104 as the destination of the data in the first UL PDU. In one implementation, the base station 106 retrieves the first UL PDU from the second UL PDU and transmits the first UL PDU to the base station 104. The base station 104 then retrieves the security-protected packet from the first UL PDU, applies security function(s) to decrypt the data and/or check the integrity protection, and transmits the data to the CN 110 (e.g., SGW 112, UPF 162, MME 114, or AMF 164) or an edge server (e.g., an edge server that can operate within the RAN 105). More specifically, the base station 104 derives security key(s) from UE context information of the UE 102. The base station 104 then retrieves the data from the security-protected packet by using the security key(s) and transmits the data to the CN 110 or edge server. In another implementation, instead of the base station 104 retrieving the security-protected packet from the first UL PDU, the base station 106 retrieves the security-protected packet from the first UL PDU. More specifically, the base station 106 can perform a retrieve UE context procedure with the base station 104 to obtain UE context information of the UE 102 from the base station 104, and then derive security key(s) from the UE context information. The base station 106 then retrieves the data from the security-protected packet by using the security key(s) and transmits the data to the CN 110 (e.g., UPF 162) or an edge server. In each of these implementations, when the security-protected packet is an encrypted packet, the base station 104 or 106 decrypts the encrypted packet to obtain the data by using the security key(s) (e.g., a (de)encryption key). If the security-protected packet is an integrity-protected packet that includes the data and the MAC-I, the base station 104 or 106 can verify whether the MAC-I is valid for the security-protected packet by using the security key(s) (e.g., an integrity key). When the base station 104 or 106 confirms that the MAC-I is valid, the base station 104 or 106 sends the data to the CN 110 or edge server. On the other hand, when the base station 104 or 106 determines the MAC-I is invalid, the base station 104 or 106 discards the security-protected packet. Further, if the security-protected packet is both encrypted and integrity-protected, and therefore includes the encrypted packet along with the encrypted MAC-I, the base station 104 or 106 decrypts the encrypted packet and the encrypted MAC-I to obtain the data and the MAC-I. The base station 104 or 106 then determines whether the MAC-I is valid for the data. If the base station 104 or 106 determines that the MAC-I is valid, the base station 104 or 106 retrieves the data and forwards the data to the CN 110 or edge server. However, if the base station 104 or 106 determines that the MAC-I is invalid, the base station 104 or 106 discards the packet.

In other scenarios and implementations, the base station 104 can retrieve and use the UE ID of the UE 102 from the UL RRC message to determine that the base station 104 stores UE context information of the UE 102. Accordingly, the base station 104 retrieves the security-protected packet from the first UL PDU, retrieves the data from the security-protected packet, and sends the data to the CN 110 or edge server as described above.

Further, in some scenarios and implementations, the RAN 105 transmits data in the DL direction to the UE 102 operating in the RRC_INACTIVE or RRC_IDLE state. In one implementation, when the base station 104 determines that data is available for DL transmission to the UE 102 currently operating in the RRC_INACTIVE or RRC_IDLE state, the base station 104 can secure the data to generate a security-protected packet, generate a first DL PDU that includes the security-protected packet, and include the first DL PDU in a second DL PDU. To secure the data, the base station 104 can apply security function(s) (e.g., integrity protection and/or encryption) to the data. More particularly, similar to the manner in which the UE 102 can secure data available for UL transmission, in applying integrity protection, the base station 104 can generate a MAC-I for protecting integrity of the data available for DL transmission, so that security-protected packet includes the DL data and the MAC-I. In applying an encryption function, the base station 104 can encrypt the data to generate an encrypted packet, so that the security-protected packet includes encrypted data. Further, when both integrity protection and encryption are applied, the base station 104 can generate a MAC-I for protecting integrity of the data and encrypt the data along with the MAC-I to generate an encrypted packet and an encrypted MAC-I.

In some implementations, the base station 104 generates a first DL PDU (e.g., a DL PDCP PDU) using the security-protected packet, includes the first DL PDU in a second DL PDU (e.g., a DL MAC PDU associated with the MAC layer), and transmits the second DL PDU to the UE 102 without causing the UE 102 to transition to the RRC_CONNECTED state. In some implementations, the base station 104 includes the DL PDCP PDU in a DL RLC PDU, and further includes the DL RLC PDU in the DL MAC PDU.

In another implementation, the base station 104 transmits the first DL PDU to the base station 106, which then generates a second DL PDU (e.g., a DL MAC PDU) that includes the first DL PDU and transmits the second DL PDU to the UE 102 without causing the UE 102 to transition to the RRC_CONNECTED state. In some implementations, the base station 106 generates a DL RLC PDU that includes the first DL PDU and includes the DL RLC PDU in the second DL PDU. In yet another implementation, the base station 104 includes the first DL PDU in a DL RLC PDU and transmits the DL RLC PDU to the base station 106, which in turn generates a second DL PDU (e.g., a DL MAC PDU) that includes the DL RLC PDU and transmits the second DL PDU to the UE 102.

In some implementations, the base station 104 or 106 generates a downlink control information (DCI) and a cyclic redundancy check (CRC) scrambled with an ID of the UE 102 to transmit the second DL PDU generated by the base station 104 or 106. In some implementations, the ID of the UE 102 can be a Radio Network Temporary Identifier (RNTI), such as a cell RNTI (C-RNTI), a temporary C-RNTI, or an inactive C-RNTI. The base station 104 or 106 can transmit the DCI and scrambled CRC on a physical downlink control channel (PDCCH) to the UE 102 operating in the RRC_INACTIVE or RRC_IDLE state. In some implementations, the base station 104 or 106 may assign the ID of the UE 102 to the UE 102 in a random access response that the base station 104 or 106 transmits in a random access procedure with the UE 102 before transmitting the DCI and scrambled CRC. In other implementations, the base station 104 or 106 may assign the ID of the UE 102 to the UE 102 in an RRC message (e.g., RRC release message or an RRC reconfiguration message) that the base station 104 or 106 transmits to the UE 102 before transmitting the DCI and scrambled CRC.

After receiving the DCI and scrambled CRC on the PDCCH, the UE 102 can confirm that a physical downlink shared channel (PDSCH), including the second DL PDU, is addressed to the UE 102 according to the ID of the UE 102, the DCI, and the scrambled CRC. The UE 102 then can retrieve the data from the security-protected packet. If the security-protected packet is an encrypted packet, the UE 102 can decrypt the encrypted packet using the appropriate decryption function and the security key to obtain the data. If the security-protected packet is the integrity-protected packet (i.e., that includes the data and the MAC-I), the UE 102 can determine whether the MAC-I is valid. If the UE 102 confirms that the MAC-I is valid, the UE 102 retrieves the data; otherwise, the UE 102 discards the data. If the security-protected packet is both encrypted and integrity-protected (i.e., includes encrypted data and an encrypted MAC-I), the UE 102 can decrypt both the encrypted packet and encrypted MAC-I to obtain the data and the MAC-I. The UE 102 then can verify whether the MAC-I is valid for the data. If the UE 102 confirms that the MAC-I is valid, the UE 102 retrieves and processes the data; otherwise, the UE 102 discards the data.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a MAC controller 132 configured to perform a random access procedure with one or more user devices (e.g., UE 102), receive UL MAC PDUs from the one or more user devices, and transmit DL MAC PDUs to the one or more user devices. The processing hardware 130 can also include a PDCP controller 134 configured to transmit and/or receive PDCP PDUs in accordance with the manner in which the base station 104 can transmit DL data and/or receive UL data, respectively. The processing hardware 130 can further include an RRC controller 136 to implement procedures and messaging at the RRC sublayer of the protocol communication stack. The processing hardware 130 in an example implementation includes an RRC inactive controller 138 configured to manage UL and/or DL communications when the one or more UEs operate in the RRC_INACTIVE or RRC_IDLE state. The base station 106 can include processing hardware 140 that is similar to processing hardware 130. In particular, components 142, 144, 146, and 148 can be similar to the components 132, 134, 136, and 138, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an RRC inactive controller 158 configured to manage UL and/or DL communications when the UE 102 operates in the RRC_INACTIVE or RRC_IDLE state. The processing hardware 150 in an example implementation includes a MAC controller 152 configured to perform a random access procedure with base station 104 or 106, transmit UL MAC PDUs to the base station 104 or 106, and receive DL MAC PDUs from the base station 104 or 106. The processing hardware 150 can also include a PDCP controller 154 configured to transmit and/or receive PDCP PDUs in accordance with the manner in which the UE 102 can transmit UL data and/or receive DL data, respectively. The processing hardware 150 can further include an RRC controller 156 to implement procedures and messaging at the RRC sublayer of the protocol communication stack.

FIG. 1B depicts an example distributed or disaggregated implementation of one or both of the base stations 104, 106. In this implementation, each of the base station 104 and/or 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller (e.g., PDCP controller 134, 144), an RRC controller (e.g., RRC controller 136, 146), and/or an RRC inactive controller (e.g., RRC inactive controller 138, 148). In some implementations, the CU 172 can include an RLC controller configured to manage or control one or more RLC operations or procedures. In other implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or an RLC controller configured to manage or control one or more RLC operations or procedures. The processing hardware can also include a physical layer controller configured to manage or control one or more physical layer operations or procedures.

In some implementations, the RAN 105 supports Integrated Access and Backhaul (IAB) functionality. In some implementations, the DU 174 operates as an (IAB)-node, and the CU 172 operates as an IAB-donor.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or SDAP protocol of the CU 172. The CU-CP 172A can transmit control information (e.g., RRC messages, F1 application protocol messages), and the CU-UP 172B can transmit data packets (e.g., SDAP PDUs or IP packets).

The CU-CP 172A can be connected to multiple CU-UPs 172B through the E1 interface. The CU-CP 172A selects the appropriate CU-UP 172B for the requested services for the UE 102. In some implementations, a single CU-UP 172B can be connected to multiple CU-CPs 172A through the E1 interface. If the CU-CP 172A and DU(s) 174 belong to a gNB, the CU-CP 172A can be connected to one or more DU 174s through an F1-C interface and/or an F1-U interface. If the CU-CP 172A and DU(s) 174 belong to an ng-eNB, the CU-CP 172A can be connected to DU(s) 174 through a W1-C interface and/or a W1-U interface. In some implementations, one DU 174 can be connected to multiple CU-UPs 172B under the control of the same CU-CP 172A. In such implementations, the connectivity between a CU-UP 172B and a DU 174 is established by the CU-CP 172A using Bearer Context Management functions.

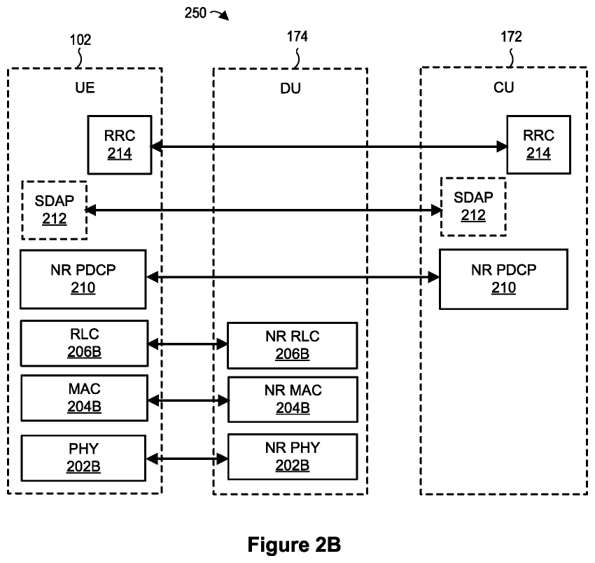

FIG. 2A illustrates, in a simplified manner, an example protocol stack 200 according to which the UE 102 can communicate with an eNB/ng-eNB or a gNB (e.g., one or both of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to a EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to the SDAP sublayer 212 or an RRC sublayer (not shown in FIG. 2A). The UE 102, in some implementations, supports both the EUTRA and the NR stack as shown in FIG. 2A, to support handover between EUTRA and NR base stations and/or to support dual connectivity (DC) over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an IP layer, layered directly or indirectly over the PDCP layer 208 or 210) that can be referred to as SDUs, and output packets (e.g., to the RLC layer 206A or 206B) that can be referred to as PDUs. Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) to the RRC sublayer (not shown in FIG. 2A) to exchange RRC messages or NAS messages, for example. On a user plane, the EUTRA PDCP sublayer 208 and the NR PDCP sublayer 210 can provide data radio bearers (DRBs) to support data exchange. Data exchanged on the NR PDCP sublayer 210 can be SDAP PDUs, IP packets, or Ethernet packets.

Thus, it is possible to functionally split the radio protocol stack, as shown by the radio protocol stack 250 in FIG. 2B. The CU at one or both of the base stations 104, 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

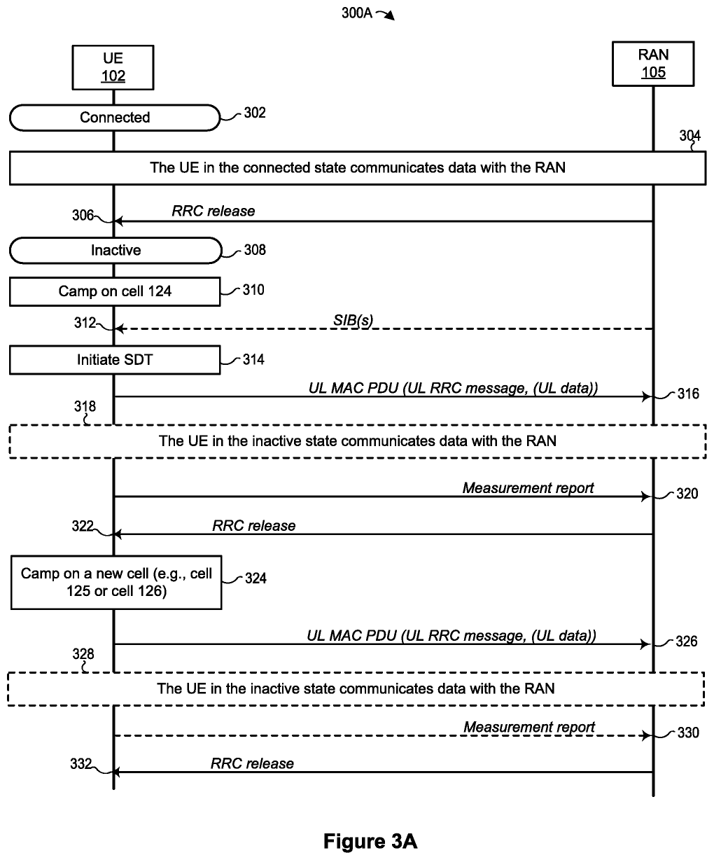

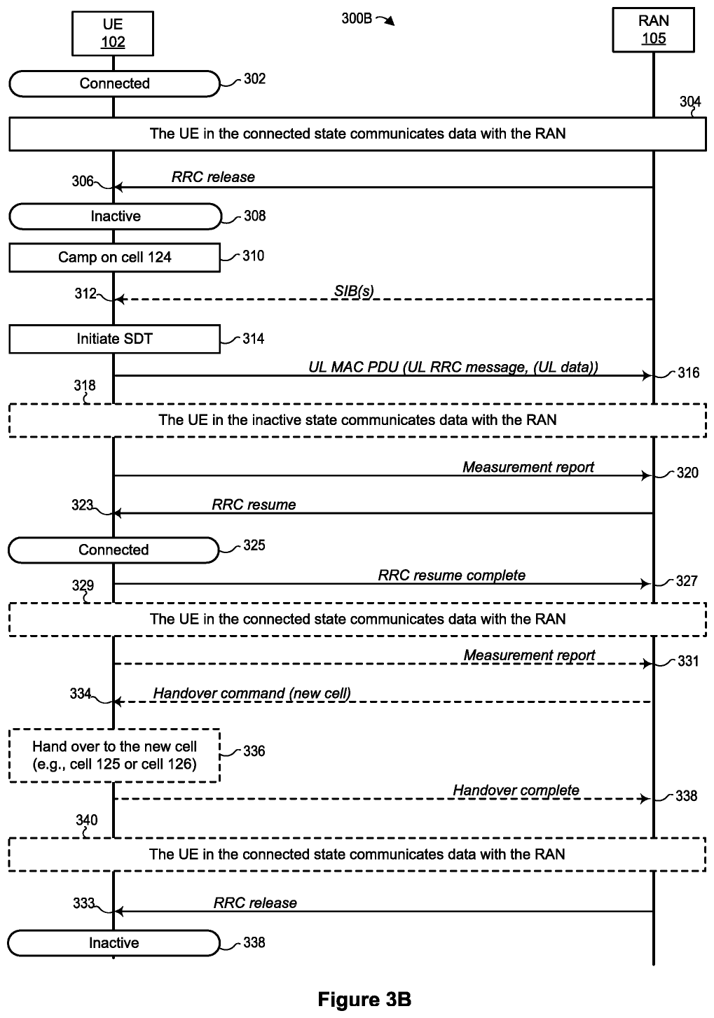

Next, several example scenarios that involve various components of FIG. 1A and relate to managing measurements (e.g., inter-frequency measurements) and SDT while the UE 102 is in an inactive or idle state are discussed next with reference to FIGS. 3A-3B. Generally speaking, events in FIGS. 3A-3B that are the same are labeled with the same reference numbers. To simplify the following description, the term “inactive state” is used to represent either the inactive (e.g., RRC_INACTIVE) or idle (e.g., RRC_IDLE) state, unless otherwise noted.

Referring first to FIG. 3A, in a scenario 300A, the UE 102 initially operates 302 in a connected (e.g., RRC_CONNECTED) state and communicates 304 data with the RAN 105 (e.g., base station 104 and/or base station 106), e.g., via one or more radio bearers (RBs). In some implementations, the UE 102 in the connected state communicates 304 control-plane (CP) data with the RAN 105 via one or more signaling RBs (SRBs). In such implementations, the CP data includes RRC PDUs that include RRC messages, NAS messages, IP packets, Ethernet packets, and/or application packets. In other implementations, the UE 102 in the connected state communicates 304 CP data and/or user-plane (UP) data with the RAN 105 via one or more data RBs (DRBs). The UP data in some example scenarios includes IP packets, Ethernet packets, and/or application packets.

While the UE 102 operates 302 in the connected state, the RAN 105 transmits to the UE 102 a plurality of configuration parameters for communicating with the UE 102 at event 304. The UE 102 communicates 304 with the RAN 105 using the configuration parameters. In some implementations, the configuration parameters include configuration parameters in a CellGroupConfig 1E as defined in 3GPP specification 38.331. While the UE 102 operates 302 in the connected state, the RAN 105 can transmit to the UE 102 one or more measurement configurations (e.g., a MeasConfig 1E). The measurement configuration(s) configure one or more carrier frequencies and include reporting configuration(s). The UE 102 in the connected state performs measurements on the one or more carrier frequencies and obtains measurement result(s) from the measurements. In some implementations, the measurement result(s) can include, or indicate RSRP, reference signal received quality (RSRQ), and/or signal to interference and noise ratio (SINR) value(s) for the one or more carrier frequencies or for one or more cells operated on the one or more carrier frequencies. In some implementations, the RAN 105 can include measurement gap configuration(s) in the measurement configuration(s) so that the UE 102 can measure a particular carrier frequency using gap(s) configured in (i.e., specified by) the measurement gap configuration(s). If the UE 102 determines/detects that a reporting condition in the reporting configuration(s) is met, the UE 102 can transmit a measurement report including the measurement result(s) to the RAN 105.

After a (first) certain period of data inactivity, the RAN 105 can determine that neither the RAN 105 nor the UE 102 has transmitted any data in the downlink direction or the uplink direction, respectively, during the certain period. In response to the determination, the RAN 105 can transmit 306 a first DL RRC message to the UE 102 to instruct the UE 102 to transition 308 to the inactive state. In some implementations, and as shown in FIG. 3A, the first DL RRC message can be a first RRC release message (e.g., RRCRelease message or RRCConnectionRelease message). In some implementations, the RAN 105 can assign an I-RNTI or a resume ID to the UE 102 and include the assigned value in the first RRC release message. In addition, the RAN 105 can include a security configuration (e.g., NextHopChainCount IE) in the first RRC release message. The UE 102 applies the security configuration to obtain one or more security keys (e.g., an encryption key and/or integrity key). The UE 102 uses the security key(s) to perform one or more security functions with respect to UL data and/or DL data in an SDT session (e.g., data exchanged between events 314 and 324 described below, including events 316, 318, 320, 322, and/or other data not shown in FIG. 3A).

In some implementations, the RAN 105 includes an SDT configuration in the first RRC release message to enable the UE 102 to perform SDT upon receiving the first RRC release message. The RAN 105 in some implementations can indicate RBs as SDT RB(s) (i.e., indicate that the RB(s) are suitable or configured for SDT) or non-SDT RB(s) (i.e., indicate that the RB(s) are unsuitable or not configured for SDT). For example, the RAN 105 can include at event 306 an SDT indication in the first RRC release message to indicate that a first SRB is an SDT RB. In cases where the RAN 105 does not include an SDT indication for a second SRB in the first RRC release message, the second SRB is a non-SDT RB by default. Alternatively, the RAN 105 can include a non-SDT indication in the first RRC release message to indicate that the second SRB is a non-SDT RB. In another similar example, the RAN 105 can include an SDT indication in the first RRC release message to indicate that a first DRB is an SDT RB. In some implementations, in cases where the RAN 105 does not include an SDT indication for a second DRB in the first RRC release message, the second DRB is a non-SDT DRB by default. Alternatively, the RAN 105 can include a non-SDT indication in the first RRC release message to indicate that the second DRB is a non-SDT RB. In other implementations, particular RB(s) (e.g., SRB0, SRB1, and/or SRB2) can be considered SDT RB(s) by default, even though the RAN 105 does not indicate that the particular RB(s) are SDT RB(s) in the first RRC release message. In such implementations, the UE 102 determines the particular RB(s) as SDT RB(s) as a default, even though the UE 102 does not receive from the RAN 105 indication(s) that identify the particular RB(s) as SDT RB(s).

The SDT configuration can include one or more SDT initiation criteria configurations, a CG configuration, multiple CG configurations, a configuration of HARQ retransmission with the CG configuration(s), a subsequent SDT configuration, a repetition configuration, a PDCCH configuration, a PUCCH configuration, and/or a PUSCH configuration, for example. The SDT configuration can also include a UL bandwidth part (BWP) configuration and/or a DL BWP configuration. Some of the configurations described above in the SDT configuration can be CG-SDT specific configurations, RA-SDT specific configurations, or common configurations for both CG-SDT and RA-SDT.

For example, the SDT initiation criteria configuration(s) can include a signal strength threshold (e.g., RSRP threshold, RSRQ threshold, SINR threshold, and/or other suitable metrics), a maximum data volume size, a maximum packet size, and/or a maximum number of packets for an SDT session. In accordance with the SDT initiation criteria configuration(s), in some implementations, the UE 102 can perform SDT (i.e., initial SDT and/or subsequent SDT) only if a signal strength obtained by the UE 102 from measurements is above the signal strength threshold specified by the SDT initiation criteria configuration(s). In some implementations, the maximum data volume size specifies a maximum number of octets for all SDT RB(s) (i.e., the RB(s) suitable or configured for SDT) that the UE 102 can transmit in an SDT session. In some implementations, the maximum packet size specifies a maximum number of octets that the UE 102 can transmit in a single SDT (i.e., an uplink MAC PDU). In other implementations, the maximum packet size specifies a maximum number of octets for a single packet that the UE 102 can transmit. The single packet can be an application data packet (e.g., IP packet or Ethernet packet), an SDAP PDU, a NAS PDU, a RRC PDU, a PDCP SDU, a PDCP PDU, or an RLC PDU.

As another example, each, or at least some, of the CG configurations(s) can include a time domain resources allocation configuration, a frequency domain resources allocation configuration, a hybrid automatic repeat request (HARQ) configuration, one or more SDT initiation criteria configurations, a repetition configuration, a PDCCH configuration, a PUCCH configuration, a PUSCH configuration, a configuration of HARQ retransmission, a frequency hopping configuration, and/or a physical layer acknowledgement configuration, which are specific for SDT using radio resources configured by the CG configuration(s). In other implementations, each, or at least some, of the CG configuration(s) can include configuration parameters similar to configuration parameters included in a ConfiguredGrantConfiguration IE as specified in 3GPP specification 38.331.

In some implementations, the subsequent SDT configuration can configure the number of subsequent data packets, the number of bytes for subsequent data, or the number of CG radio resources that the UE 102 is allowed to use or transmit for subsequent UL data in an SDT session. In cases where the RAN 105 does not provide the UE 102 with the subsequent SDT configuration, the UE 102 is consequently disabled from transmitting subsequent UL data in an SDT session, in one implementation. Alternatively, the UE 102 is allowed to transmit subsequent UL data without any restriction, in cases where the RAN 105 does not provide the UE 102 with the subsequent SDT configuration. In some implementations, the repetition configuration enables or configures the UE 102 to transmit repetitions of a UL transmission (e.g., a PUSCH transmission or a UL MAC PDU) in an SDT session. In cases where the RAN 105 does not provide the UE 102 with the repetition configuration, the UE 102 is consequently disabled from transmitting repetitions for a UL transmission in an SDT session.

In some implementations, the RAN 105 can indicate one or more carrier frequencies (e.g., NR carriers, EUTRA carriers) for the UE 102 to measure while the UE 102 operates in the inactive state, in the first RRC release message. In some implementations, the UE 102 can receive a measurement configuration (e.g., CellReselectionPriorities IE or MeasldleConfigDedicated-r16 IE) included in first RRC release message received from the RAN 105 at event 306.

In response to or upon receiving the first RRC release message at event 306, the UE 102 transitions 308 to the inactive state and retains a portion or all of the configuration parameters that the UE 102 applied to communicate with the RAN 105 while operating in the connected state. The UE 102 also retains the measurement configuration(s) upon transitioning to the inactive state. In some implementations in which either the base station 104 or base station 106 of the RAN 105 is a distributed or disaggregated base station including a CU 172 and DU 174 as described in FIG. 1B, after the UE 102 transitions to the inactive state, the UE 102 can perform one or more RAN notification area (RNA) updates with the CU 172 via the DU 174 without state transitions (e.g., without transitioning from the inactive state back to the connected state).

After the UE 102 transitions 308 to the inactive state, the UE 102 camps 310 (e.g., selects or reselects) on cell 124. In some implementations, the RAN 105 (e.g., the base station 104) can send, e.g., at event 312, a request via system information (e.g., SIB(s)) to the UE 102, for the UE 102 to measure one or more carrier frequencies (e.g., NR carriers, EUTRA carriers) while the UE 102 operates in the inactive state. In turn, the UE 102 can receive 312 system information block(s) (SIB(s)) on the cell 124. Although scenario 300A illustrates the UE 102 receiving 312 the SIB(s) after the UE 102 transitions to the inactive state at event 308, in other scenarios and implementations, the UE 102 can receive the SIB(s) before receiving 306 the first RRC release message. The SIB(s) include information of one or more carrier frequencies for cell reselection, idle measurements, and/or inactive measurements.

The UE 102 in the inactive state performs measurements on a carrier frequency of cell 124 for cell selection or reselection. In cases where the UE 102 receives 312 the SIB(s) or the measurement configuration in the first RRC release message, the UE 102, while still in the inactive state, can perform measurements on the one or more carrier frequencies indicated in the SIB(s) or the measurement configuration in the first RRC release message.

In some implementations, the UE 102 in the inactive state performs measurements on a portion or all of the one or more carrier frequencies indicated in the measurement configuration(s). In other implementations, the UE 102 in the inactive state suspends performing measurements on a portion or all of the one or more carrier frequencies indicated in the measurement configuration(s). For example, in cases where the one or more carrier frequencies includes the carrier frequency of the cell 124, the UE 102 refrains from suspending performing measurements on the carrier frequency of the cell 124.

In some implementations, the SIB(s) include SIB4, SIB5 and/or SIB11 if the cell 124 is an NR cell. For example, the SIB4 can contain information relevant for inter-frequency cell reselection (i.e., information about other NR carrier frequencies and inter-frequency neighboring cells relevant for cell reselection), which can also be used for NR idle/inactive measurements. The SIB4 can also include cell reselection parameters common for a frequency as well as cell specific reselection parameters. In another example, the SIB5 can contain information relevant only for inter-RAT cell reselection, i.e., information about EUTRA carrier frequencies and EUTRA neighboring cells relevant for cell reselection. The SIB5 can also include cell reselection parameters common for a frequency. In yet another example, the SIB11 can contain NR carrier frequencies for idle/inactive measurements.

In other implementations, the SIB(s) include SystemInformationBlockType5 and/or SystemInformationBlockType24 if the cell 124 is an EUTRA cell. For example, the SystemInformationBlockType5 can contain information about other EUTRA frequencies and inter-frequency neighboring cells relevant for cell reselection (including cell reselection parameters common for a frequency as well as cell-specific reselection parameters). The SystemInformationBlockType5 can also contain information about EUTRA and NR idle/inactive measurements. In another example, the SystemInformationBlockType24 can contain information relevant for inter-RAT cell reselection (i.e., information about NR frequencies and NR neighboring cells relevant for cell reselection), which can also be used for NR idle/inactive measurements. The SystemInformationBlockType24 can include cell reselection parameters common for a frequency.

At a later time, the UE 102 in the inactive state initiates 314 SDT (e.g., in accordance with the SDT configuration received in event 306) to transmit UL data or receive DL data. In cases of transmitting UL data while the UE 102 is in the inactive state, the SDT is referred to as mobile originating (MO) SDT. In cases of receiving DL data while the UE 102 is in the inactive state, the SDT is referred to as mobile terminating (MT) SDT (i.e., small data reception from the viewpoint of the UE 102). In such cases, the UE 102 at event 314 receives from the RAN 105 a paging message, which includes a UE ID of the UE 102 and an SDT indication. The UE ID can be an I-RNTI, a resume ID, or a NAS ID (e.g., S-TMSI or 5G-S-TMSI). In response to the paging message (i.e., the UE ID and the SDT indication), the UE 102 initiates SDT.

In some implementations, the UE 102 can initiate SDT only if a signal strength obtained by the UE 102 from measuring a serving carrier frequency of the cell 124 exceeds a signal strength threshold specified by the SDT initiation criteria configuration(s). If the signal strength exceeds the signal strength threshold, the UE 102 can begin performing SDT via the cell 124.

In some implementations, the UE 102 can determine whether the UL data for transmission during SDT qualifies for transmission in the inactive state in view of one or more factors, such as whether the UL data is an IMS packet, whether the UL data is associated with a radio bearer (e.g., DRB or SRB) not suitable or configured for SDT, whether the UL data is a NAS message for initiating a particular NAS procedure, the size of the data, and/or one or more other factors. If the UE 102 determines that the UL data does not qualify for transmission in the inactive state, the UE 102 can perform an RRC procedure (e.g., RRC connection establishment procedure or RRC resume procedure) to transition to the connected state.

In cases where the UE 102 suspends performance of measurements on the one or more carrier frequencies indicated in the measurement configuration(s), the UE 102 in some implementations can resume performance of the measurements in response to or after initiating the SDT or during the SDT session (i.e., after initiating 314 SDT and before receiving 322 a RRC release message, and including event 316 and/or 318), as will be described further below. After the UE 102 stops or otherwise completes performing SDT (i.e., the SDT session ends), the UE 102 can suspend performance of the measurements, in some implementations. For example, the UE 102 can suspend performance of the measurements upon receiving 322 or 326 the DL RRC message.

After or in response to initiating 314 the SDT, the UE 102 transmits 316 an initial UL MAC PDU to RAN 105 on the cell 124. In cases of MO SDT, the UE 102 can include UL data in the initial UL MAC PDU, and the RAN 105 retrieves the UL data from the initial UL MAC PDU. In cases of MT SDT, the UE 102 does not include UL data in the initial UL MAC PDU. The UL RRC message can be a CCCH message, an RRC resume request message, or an RRC early data request message, as described above in reference to FIG. 1A. For MO SDT, the UL RRC message can include a cause value (e.g., “mo-data”), which can be a field or information element (IE) (e.g., resumeCause or ResumeCause). For MT SDT, the UL RRC message can include an SDT indication, which can be a field IE (e.g., resumeCause or ResumeCause).

In some implementations, to transmit the initial UL MAC PDU at event 316, the UE 102 in the inactive state performs a random access procedure with the RAN 105 on the cell 124. For example, the random access procedure can be a four-step random access procedure or a two-step random access procedure. In the case of the four-step random access procedure, the UE 102 transmits a random access preamble to the RAN 105, the RAN 105 in response transmits to the UE 102 a random access response (RAR) including an uplink grant, and the UE 102 transmits 316 the UL MAC PDU in accordance with the uplink grant. The RAN 105 receives 316 the UL MAC PDU in accordance with the uplink grant in the RAR. In the case of the two-step random access procedure, the UE 102 transmits 316 to the RAN 105 a message A including a random access preamble and the UL MAC PDU in accordance with two-step random access configuration parameters. The UE 102 can receive the two-step random access configuration parameters in system information broadcast by the RAN 105 on cell 124 before transmitting 316 the UL MAC PDU. The RAN 105 receives 316 the UL MAC PDU in accordance with the two-step random access configuration parameters. In further implementations, the UE 102 can transmit 316 the UL MAC PDU on radio resources configured in CG configuration(s). The RAN 105 can include the CG configuration to the UE 102 in the first RRC release message, as described above. Thus, the RAN 105 receives 316 the UL MAC PDU on the radio resources.

After receiving 316 the UL RRC message and/or the UL data, the RAN 105 refrains from transitioning the UE 102 to a connected state and communicates 318 data (i.e., UL data and/or DL data) with the UE 102 operating in the inactive state. In some implementations, the data at event 316 or 318 can include at least one data packet for an application or a protocol layer, such as an MM layer (e.g., 5G MM), an SM layer (e.g., 5G SM), an LTE positioning protocol (LPP) layer, or a secure user-plane location (SUPL) protocol layer. The data packet can be an IP packet, an Ethernet packet, or an application packet. In other implementations, the data packet can be a PDCP PDU that includes an RRC PDU, an MM PDU, an SM PDU, an LPP PDU, an IP packet, an Ethernet packet, or an application packet. In yet other implementations, the data packet can be an RRC PDU including a NAS PDU, such that the NAD PDU includes an IP packet, an Ethernet packet, or an application packet. More specifically, at event 318, the UE 102 can transmit to the RAN 105 one or more UL MAC PDUs, and/or the RAN 105 can transmit to the UE 102 one or more DL MAC PDUs, where each of the UL MAC PDU(s) and/or DL MAC PDU(s) can include a particular data packet or a particular segment of a data packet. In some implementations, at event 318, the UE 102 can transmit each, or at least some, of the UL MAC PDU(s) on radio resources configured in the CG configuration(s) described above. In other implementations, the RAN 105 can transmit to the UE 102 one or more DCIs for the UE 102 on PDCCH(s) where each of the DCI(s) includes an uplink grant. In such cases, at event 318, the UE 102 transmits each, or at least some, of the UL MAC PDU(s) on radio resources assigned by the uplink grant(s). Similarly, the RAN 105 can transmit one or more DCIs for the UE 102 on PDCCH(s), where each of the DCI(s) includes a downlink assignment. In such cases, at event 318, the UE 102 receives the DL MAC PDU(s) on radio resources assigned by the downlink assignment(s).

In some implementations, the RAN 105 can transmit the DCI(s) on the PDCCH(s) via the cell 124 using a search space for SDT (i.e., SDT-specific search space). The RAN 105 can include an SDT-specific search space configuration specifying/configuring the SDT-specific search space in the first DL RRC message. Alternatively, the RAN 105 can broadcast a SIB including the SDT-specific search space configuration via the cell 124 and/or other cell(s) (e.g., cell 125 and/or cell 126). In such cases, the UE 102 can use the SDT-specific search space to receive the DCI(s) on the PDCCH(s) via the cell 124. In cases where the RAN 105 does not provide an SDT-specific search configuration to the UE 102, the RAN 105 can transmit the DCI(s) on the PDCCH(s) using a common search space. In such cases, the UE 102 can use the common search space to receive the DCI(s) on the PDCCH(s) via the cell 124. The RAN 105 can broadcast, via the cell 124, a SIB including a common search space configuration specifying/configuring the common search space.

Generally, when the RAN 105 receives all segments of a data packet from the UE 102, the RAN 105 assembles the segments to obtain the data packet and can process the data packet or send the data packet to the CN 110. In some implementations, the UE 102 at event 318 can transmit a plurality of segments of a particular data packet for an application or a protocol layer to the RAN 105, until all segments of the data packet are transmitted to the RAN 105. Similarly, when the UE 102 receives all segments of a data packet from the RAN 105 at event 318, the UE 102 assembles the segments to obtain the data packet.

After a (second) certain period of data inactivity for the UE 102, the RAN 105 can determine that neither the RAN 105 nor the UE 102 has transmitted any data in the downlink direction or the uplink direction after events 316 and/or 318, respectively, during the (second) certain period. In response to the determination, the RAN 105 can transmit 322 a second DL RRC message (e.g., a second RRC release message) to the UE 102, similar to event 306. In some implementations, the UE 102 can receive a DCI configuring a downlink assignment on a PDCCH from the RAN 105 and receive 322 the second DL RRC message on radio resources configured in the downlink assignment. In some implementations, the UE 102 can receive the DCI on the PDCCH via the cell 124 using the SDT-specific search space configuration. In cases where the UE 102 does not receive an SDT-specific search space configuration from the RAN 105, the UE 102 can receive the DCI on the PDCCH via the cell 124 using the common search space configuration.

In response to the second DL RRC message, the UE 102 remains in the inactive state and stops SDT. In some implementations, the RAN 105 can assign an I-RNTI or a resume ID to the UE 102 and include the assigned value in the second RRC release message. In addition, the RAN 105 can include a security configuration (e.g., NextHopChainCount IE) in the second RRC release message. The UE 102 apply the security configuration to obtain one or more security keys (e.g., encryption key and/or integrity key) and use the security key(s) to perform one or more security functions for UL data and/or DL data communicated with the RAN 105 in the next SDT session. In some implementations, the first and second periods of data inactivity are the same time period. In other implementations, the first and second periods of data inactivity are different.

In some alternative implementations, the second DL RRC message can be an RRC reject message instead of an RRC release message. In such cases, the RAN 105 in one implementation may apply the security function (e.g., integrity protection) to the RRC reject message. Alternatively, the RAN 105 does not apply the security function(s) to the RRC reject message.

During the SDT session, the UE 102 can transmit 320 a measurement report (e.g., a MeasurementReport message or a MAC control element) to the RAN 105. In cases where the UE is configured with the CG configuration, the UE 102 can transmit 320 the measurement report on radio resources configured in the CG configuration. Alternatively, the UE 102 can receive a DCI configuring an uplink grant on a PDCCH from the RAN 105 and transmit 320 the measurement report on radio resources specified/configured in the uplink grant. In some implementations, the RAN 105 can transmit the DU on the PDCCH using the SDT-specific search space configuration. In such cases, the UE 102 can receive the DCI on the PDCCH using the SDT-specific search space configuration. In cases where the RAN 105 does not provide an SDT-specific search configuration to the UE 102, the RAN 105 can transmit the DCI on the PDCCH using the common search space configuration. In such cases, the UE 102 can receive the DCI on the PDCCH using the common search space configuration.

In cases where the measurement report is the MeasurementReport message, the UE can transmit 320 the MeasurementReport message to the RAN 105 via SRB1. In cases where the measurement report is the MAC control element, the UE can transmit 320 an UL MAC PDU including the MAC control element message to the RAN 105. In some implementations, the UE 102 can obtain measurement result(s) from the measurements on the carrier frequency of the cell 124. In other implementations, the UE 102 can obtain measurement result(s) from the measurements on one or more carrier frequencies indicated in the measurement configuration(s) or the SIB(s). The UE 102 determines that the reporting condition(s) is met in accordance with the reporting configuration(s). In response to the determination, the UE 102 transmits 320 the measurement report including the measurement result(s) to the RAN 105.

In cases where the measurement result(s) indicates that signal strength/quality of the cell 124 is below a threshold, the RAN 105 can transmit 322 to the UE 102 the second RRC release message configuring SDT. In order to configure SDT for the UE 102, the RAN 105 can determine to transmit 322 the second RRC release message, even though the UE 102 still has data activity with the RAN 105. After receiving 322 the second RRC release message and stopping the SDT session, the UE 102 in the inactive state selects or reselects to a new cell (e.g., cell 125 or 126) from the cell 124.

In some implementations, the RAN 105 can indicate the UE 102 to use the (current) SDT configuration (i.e., received at event 306) in the second DL RRC message. In other implementations, the RAN 105 can include a second SDT configuration in the second DL RRC message to update the current SDT configuration. The second SDT configuration can include one or more configurations similar to the current SDT configuration described above.

In some implementations, the measurement result(s) can include a measurement result of the new cell. If the measurement result indicates the new cell is suitable or better than the cell 124, the RAN 105 can include and/or frequency information (a carrier frequency) of the new cell in the second RRC release message to (re)command the UE 102 to (re)select the new cell. For example, the cell information and frequency information can include a (physical) cell identity of the new cell and/or a frequency channel number (e.g., an (NR) absolute radio frequency channel number) identifying the carrier frequency of the new cell, respectively. Thus, the UE 102 can immediately (re)select the new cell in response to the second RRC release message.

After camping 324 on the new cell, the UE 102 can initiate SDT with the RAN 105 via the new cell because the UE 102 still has a valid SDT configuration as described below. In response to the initiation, the UE 102 communicates 326 a UL MAC PDU and optionally communicates 328 UL data and/or DL data with the RAN 105 via the new cell, similar to the event 316 and event 318, respectively. Moreover, in some implementations and/or scenarios, after event 324, the RAN 105 (e.g., the base station 104) can send a request via system information (e.g., SIB(s)) to the UE 102, for the UE 102 to measure one or more carrier frequencies (e.g., NR carriers, EUTRA carriers), e.g., similar to event 312. After a (third) certain period of data inactivity for the UE 102, the RAN 105 can determine that neither the RAN 105 nor the UE 102 has transmitted any data in the downlink direction or the uplink direction after events 326 and/or 328, respectively, during the (third) certain period. In response to the determination, the RAN 105 can send 332 a third DL RRC message (e.g., a third RRC release message) via the new cell to the UE 102, similar to events 306 or 322. In response to the third DL RRC message, the UE 102 remains in the inactive state and stops SDT. In some implementations, the second and third periods of data inactivity are the same time period. In other implementations, the second and third periods of data inactivity are different.

After transmitting 326 the UL MAC PDU, and during the event 328 or otherwise before receiving 332 the third DL RRC message, the UE 102 in the inactive state can transmit 330 a measurement report including one or more measurements of the cell new cell to the RAN 105. In some implementations, the UE can transmit 330 the measurement report to the RAN 105, similar to the event 320. In such cases, the RAN 105 can transmit 332 the third DL RRC message to the UE 102 based on the measurement report, similar to the event 322.

In some implementations, the RAN 105 can determine the first, second, and/or third periods based on the RB(s) with which the UL data and/or DL data at event 304, event 316 or 318, and/or event 326 or 328 are associated, respectively. For example, in case of a first RB where the UL data and/or DL data at event 304, event 316 or 318, and/or event 326 or 328 are associated, respectively, the RAN 105 can set the first, second and/or third periods to a first time period. In case of a second RB where the UL data and/or DL data at event 304, event 316 or 318, and/or event 326 or 328 are associated, respectively, the RAN 105 can set the first, second, and/or third periods to a second time period. In case of a third RB where the UL data and/or DL data at event 304, event 316 or 318, and/or event 326 or 328 are associated, respectively, the RAN 105 can set the first, second, and/or third periods to a third time period. In other implementations, the RAN 105 determine the first, second and/or third periods irrespective of RB(s). For example, the RAN 105 determine the first, second and/or third periods to be the same time period. In yet other implementations, the RAN 105 can determine that determine the first, second, and/or third periods to be different time periods. For example, the RAN 105 can determine that determine the first time period is longer than the first and second time periods. The first and second time period can the same or different.

Turning to FIG. 3B, a scenario 300B is similar to scenario 300A. Whereas the RAN 105 in scenario 300A transmits 322 the second DL RRC message (e.g., an RRC release message or an RRC reject message) to the UE 102 to transition the UE 102 to (or maintain the UE 102 in) the inactive state, however, the RAN 105 in scenario 300B transmits 323 an RRC resume message (e.g., RRCResume message or RRCConnectionResume message) to the UE 102 to transition the UE 102 to the connected state. In some implementations, the UE 102 can transmit 320 to the RAN 105 the measurement report indicating that signal strength/quality of the cell 124 is below a threshold, as described above.

In some implementations, the UE 102 can transmit to the RAN 105 an RRC indication message to request transitioning to the connected state (or to indicate that the connected state is preferred) in cases where the UE 102 detects or determines one or more radio conditions of cell 124 is/are met. For example, the radio condition(s) may include 1) a signal strength/quality of the cell 124 is below a threshold or otherwise not suitable, based on the measurements or the measurement result(s) described above; 2) a block error rate of the communication with the RAN via the cell 124 is higher than a threshold; and/or 3) a radio link quality of the cell 124 is below a threshold. Otherwise, in some implementations, the UE 102 does not transmit the RRC indication message to the RAN 105. In some implementations, the UE 102 can receive the threshold from the RAN 105. For example, the RAN 105 can transmit an RRC message (e.g., the first RRC release message or an RRC reconfiguration message) including the threshold to the UE 102 via a cell (e.g., the cell 124, the cell 125, the cell 126, or another cell). In another example, the RAN 105 can broadcast a SIB including the threshold via the cell 124. In other implementations, the UE 102 can set the threshold to a preconfigured, predetermined, or default value. In some implementations, the RRC indication message can be a UEAssistanceInformation message. In other implementations, the RRC indication message can be a new UL RRC message, e.g., included in a UL-DCCH-Message as defined in the 3GPP specification 38.331 release 17 version or later version(s). In some implementations, the RRC indication message includes an indication field/IE indicating the connected state is preferred or requested or SDT is no longer suitable. For example, the indication field/IE can be defined in the 3GPP specification 38.331 release 17 version. In other implementations, the RRC indication message includes a cause value indicating a cause why the UE 102 prefers the connected state or SDT is no longer suitable. For example, the cause value can indicate that the radio condition(s) is/are met. In another example, the cause value can be defined in the 3GPP specification 38.331 release 17 version. In some implementations, the UE 102 can include, in the RRC indication message, measurement result(s) indicating the signal strength/quality of the cell 124 and/or signal strength/quality of the cell 125 and/or the cell 126. The UE 102 can apply the security function(s) to the RRC indication message to secure-protect the RRC indication message as described herein for protecting the UL data packet.

In response to the measurement result(s) or the RRC indication message, the RAN 105 can determine to use advanced technique(s) developed for the connected state to improve quality of communication with the UE 102. For example, the techniques can include link adaption, beamforming, transmit diversity, coverage enhancement (e.g., repetitions), close-loop power control, interference cancellation, and/or handover. In some implementations, the RAN 105 can transmit 323 to the UE 102 the RRC resume message on radio resources configured in the CG configuration. In other implementations, the RAN 105 can transmit to the UE 102 a DCI for the UE 102 on a PDCCH using the SDT-specific search space configuration, where the DCI includes a downlink assignment. In such cases, the UE 102 can receive the DCI on the PDCCH using the SDT-specific search space configuration. In cases where the RAN 105 does not provide an SDT-specific search space configuration to the UE 102, the RAN 105 can transmit the DCI on a PDCCH using a common search space configuration. In such cases, the UE 102 can receive the DCI on the PDCCH using the common search space configuration.

In response to determining to use the advanced technique(s) for communication with the UE 102, the RAN 105 transmits 323 the RRC resume message to the UE 102 to transition the UE 102 to the connected state. In response to the RRC resume message, the UE 102 transitions 325 to the connected state and transmits 327 an RRC resume complete message (e.g., RRCResumeComplete message or RRCConnectionResumeComplete message) to the RAN 105. In some implementations, the UE 102 can transmit 327 to the RAN 105 the RRC resume complete message on radio resources configured by the CG configuration(s). In other implementations, the RAN 105 can transmit to the UE 102 a DCI for the UE 102 on a PDCCH, where the DCI includes an uplink grant. In such cases, the UE 102 transmits 327 to the RAN 105 the RRC resume complete message on radio resources assigned in the uplink grant. In some implementations, the RAN 105 can transmit the DCI on the PDCCH via the cell 124 using the SDT-specific search space configuration. In such cases, the UE 102 can receive the DCI on the PDCCH via the cell 124 using the SDT-specific search space configuration. In cases where the RAN 105 does not provide an SDT-specific search space configuration to the UE 102, the RAN 105 can transmit the DCI on the PDCCH via the cell 124 using the common search space configuration. In such cases, the UE 102 can receive the DCI on the PDCCH via the cell 124 using the common search space configuration. In some implementations, the RRC resume message can include a first search space configuration configuring a first search space. In such cases, the RAN 105 can transmit the DCI including the uplink grant on the PDCCH using the first search space configuration, and the UE 102 can receive the DCI on the PDCCH via the cell 124 using the first search space configuration. In some implementations, the UE 102 can stop monitoring PDCCH(s) on the cell 124 using the SDT-specific search space configuration, in response to or after receiving the RRC resume message or the first search space configuration. In some implementations, the RAN 105 can configure the first search space to overlap with the SDT-specific search space in the first search space configuration. More specifically, the RAN 105 can configure PDCCH occasions configured in the first search space to partially or completely overlap with PDCCH occasions configured in the SDT-specific search space. Thus, the UE 102 can seamlessly monitor PDCCH(s) for data communication with the RAN 105 upon transitioning from the SDT to non-SDT (i.e., data communication in the connected state). In some implementations, a periodicity of PDCCH occasions configured in the first search space can be shorter than or equal to a periodicity of PDCCH occasions in the SDT-specific search space.

In some implementations, the UE 102 can include one or more measurement results in the RRC resume complete message. The UE 102 can perform measurements on the one or more carrier frequency as described above and obtain the one or more measurement results from the measurements.

After transitioning 325 to the connected state or transmitting 327 the RRC resume complete message, the RAN 105 can communicate 329 UL data and/or DL data with the UE 102. More specifically, at event 329, the UE 102 can transmit to the RAN 105 one or more UL MAC PDUs, and/or the RAN 105 can transmit to the UE 102 one or more DL MAC PDUs, where each of the UL MAC PDU(s) and/or DL MAC PDU(s) can include a particular data packet or a particular segment of a data packet. In some implementations, the RAN 105 can transmit to the UE 102 one or more DCIs for the UE 102 on PDCCH(s), where each of the DCI(s) includes an uplink grant. In such cases, at event 329, the UE 102 transmits each, or at least some, of the UL MAC PDU(s) on radio resources assigned by the uplink grant(s). Similarly, the RAN 105 can transmit one or more DCIs for the UE 102 on PDCCH(s), where each of the DCI(s) includes a downlink assignment. In such cases, at event 329, the UE 102 receives the DL MAC PDU(s) on radio resources assigned by the downlink assignment(s). In some implementations, the UE 102 can use the first search space configuration to receive the DCI(s) on the PDCCH(s) via the cell 124.

In some implementations, the RAN 105 can include configuration parameters for some or all of the advanced technique(s) in the RRC resume message. The UE 102 applies the configuration parameters to communicate 329 with the RAN 105 in response to or after receiving the RRC resume message. In other implementations, the RAN 105 can transmit a RRC reconfiguration message (e.g., RRCReconfiguration message) including configuration parameters for some or all of the advanced technique(s) to the UE 102 after transmitting the RRC resume message. In response to or after receiving the RRC reconfiguration message, the UE 102 applies the configuration parameters to communicate 329 with the RAN 105 and transmits a RRC reconfiguration complete message (e.g., RRCReconfigurationComplete message) to the RAN 105. With these advanced techniques, the UE 102 in the connected state can continue to communicate 329 data with the RAN 105 via the cell 124 where signal strength/quality is not suitable for communication in the inactive state.

While the UE 102 operates in the connected state (i.e., after event 325), the UE 102 can transmit 331 a measurement report (e.g., MeasurementReport message) including one or more measurement results to the RAN 105, similar to the event 320. In some implementations or scenarios, the measurement result(s) received in the event 320, 327, or 331 indicates that a new cell (e.g., cell 125 or 126) is better than the cell 124 for the UE 102 to communicate with the RAN 105, the RAN 105 can determine to trigger a handover for the UE 102. In response to the determination, the RAN 105 can transmit 334 to the UE 102 a handover command message including cell information and/or frequency information of the new cell. For example, the cell information and frequency information can include a (physical) cell identity of the new cell and/or a frequency channel number (e.g., an (NR) absolute radio frequency channel number) identifying the carrier frequency of the new cell, respectively. In response to or after receiving the handover command message, the UE 102 performs 336 a handover to the new cell and transmits 338 a handover complete message to the RAN 105 via the new cell. In cases where the new cell (e.g., the cell 126) is operated by another base station (e.g., the base station 106), the handover is an inter-base station handover. In cases where the new cell is operated by the base station 104, the handover is an intra-base station handover.

In some implementations, the handover command message and handover complete message can be an RRC reconfiguration message (e.g., RRCReconfiguration message) and an RRC reconfiguration complete message (e.g., RRCReconfigurationComplete message), respectively. In some implementations, the handover command message can include a second search space configuration configuring a second search space. After handing over to the new cell, the UE 102 monitors PDCCH(s) on the new cell from the RAN 105 using the second search space configuration. In some implementations, the second search space configuration can be different from the first search space configuration. In other implementations, the second search space configuration can be the same as the first search space configuration. In other alternative implementations, the handover command message can indicate that the UE 102 is to use the first search space configuration. In such cases, the UE 102 monitors PDCCH(s) on the new cell from the RAN 105 using the first search space configuration.

After handing over to the new cell, the UE 102 in the connected state communicates 340 UL data and/or DL data with the RAN 105 via the new cell. More specifically, at event 340, the UE 102 can transmit to the RAN 105 one or more UL MAC PDUs, and/or the RAN 105 can transmit to the UE 102 one or more DL MAC PDUs, where each of the UL MAC PDU(s) and/or DL MAC PDU(s) can include a particular data packet or a particular segment of a data packet. In some implementations, the RAN 105 can transmit to the UE 102 one or more DCIs for the UE 102 on PDCCH(s), where each of the DCI(s) includes an uplink grant. In such cases, at event 340, the UE 102 transmits each, or at least some, of the UL MAC PDU(s) on radio resources assigned by the uplink grant(s). Similarly, the RAN 105 can transmit one or more DCIs for the UE 102 on PDCCH(s), where each of the DCI(s) includes a downlink assignment. In such cases, at event 340, the UE 102 receives the DL MAC PDU(s) on radio resources assigned by the downlink assignment(s). In some implementations, the UE 102 can use the second search space configuration to receive the DCI(s) on the PDCCH(s) via the new cell from the RAN 105.

Later in time, the RAN 105 can transmit 333 an RRC release message to the UE 102 via the new cell to transition the UE 102 to the inactive state, similar to the events 306, 322, or 332.

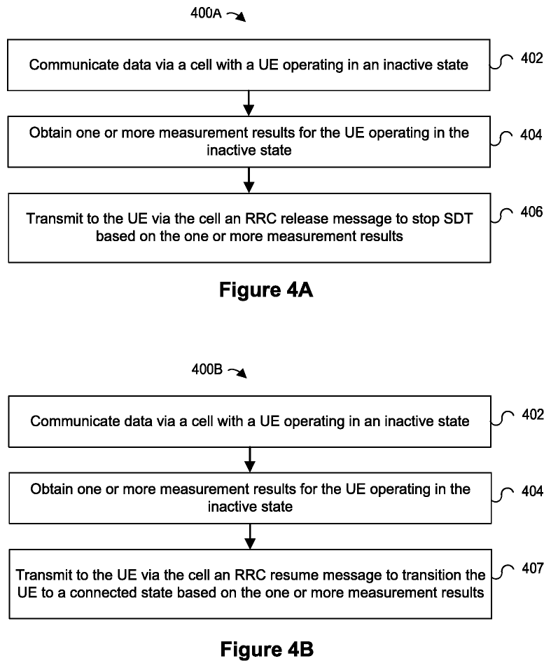

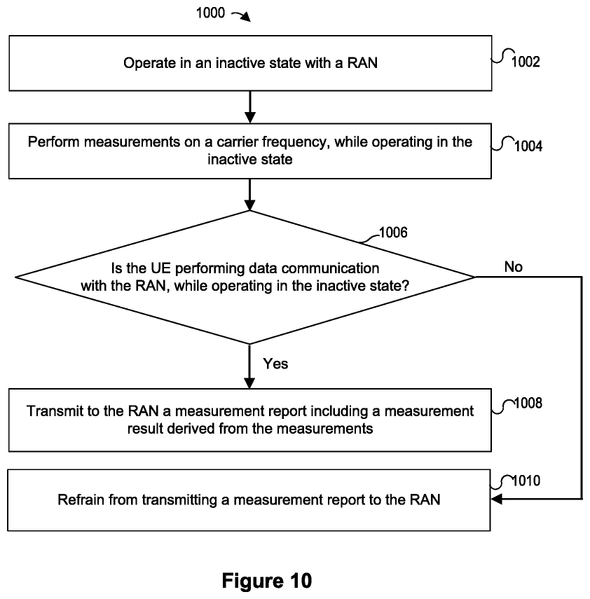

FIGS. 4A-8 are flow diagrams depicting example methods that one or more nodes of a RAN (e.g., RAN 105, or specifically base station 104, base station 106, CU 172, CU 172 with DU 174, CU-CP 172A, etc.) can implement to manage various aspects of an SDT session with a UE (e.g., the UE 102) operating in an inactive state. FIGS. 9-14 are flow diagrams depicting example methods that a UE (e.g., the UE 102) can implement to manage measurements during an SDT session.

Turning first to FIG. 4A, a RAN (e.g., RAN 105, base station 104/106, CU 172, CU-CP 172A, etc.) can implement an example method 400A to determine to stop an SDT session with a UE (e.g., the UE 102) based on one or more measurement results. The method 400A begins at block 402, where the RAN communicates data via a cell with the UE operating in an inactive state (e.g., events 316, 318, 326, 328). At block 404, the RAN obtains one or more measurement results for the UE operating in the inactive state. In some implementations, the RAN receives the one or more measurement results via the cell from the UE operating in the inactive state (e.g., events 320). Alternatively, the RAN can obtain the one or more measurement result by measuring uplink transmissions transmitted by the UE via the cell. The uplink transmissions can include reference signals (e.g., demodulation reference signals and/or sounding reference signals), physical uplink shared channel (PUSCH) transmissions, and/or PUCCH transmission, for example. At block 406, the RAN transmits to the UE an RRC release message to transition the UE to the inactive state based on (e.g., in response to) the one or more measurement results (e.g., event 322, 332). In some implementations, the RAN determines to transmit or transmits the RRC release message to the UE to stop communicating with the UE.

In some implementations, the RAN transmits the RRC release message to the UE in response to signal strength/quality of the cell indicated in the one or more measurement result(s) being below a threshold. In cases where signal strength/quality of the cell indicated in the one or more measurement result(s) is above the threshold, the RAN may transmit the RRC release message to the UE in response to detecting data inactivity for the UE 102. In some implementations, the RAN can transmit the threshold to the UE while the UE operates in a connected state (e.g., event 304).

FIG. 4B is a flow diagram of an example method 400B, which is similar to the method 400A except the RAN transitions the UE to the connected state at block 407 instead of transitioning the UE to the inactive state at block 406. At block 407, the RAN transmits to the UE a RRC resume message to transition the UE to a connected state based on (e.g., in response to) the one or more measurement results (e.g., event 323).

In some implementations, the RAN transmits the RRC resume message to the UE in response to signal strength/quality of the cell indicated in the one or more measurement result(s) being below a first threshold. In cases where signal strength/quality of the cell indicated in the one or more measurement result(s) is above the first threshold, the RAN may transmit the RRC release message to the UE in response to detecting data inactivity for the UE 102 (e.g., events 322, 332). In some implementations, the RAN can transmit the first threshold to the UE while the UE operates in a connected state (e.g., event 304).

In some implementations, the RAN can receive one or more measurement result(s) from the UE after transitioning the UE to the connected state (e.g., event 330). In response to signal strength/quality of the cell indicated in the one or more measurement result(s) being below a second threshold and/or signal strength/quality of a new cell indicated in the one or more measurement result(s) being above a third threshold, the RAN may transmit a handover command message to the UE to hand over the UE to the new cell. In some implementations, the RAN can transmit the second threshold and/or third to the UE while the UE operates in the connected state (e.g., event 304). In some implementations, the RAN can include the second and/or third threshold in the handover command message. In some implementations, the first, second, and/or third thresholds are the same. In other implementations, the first, second, and/or third thresholds are different.

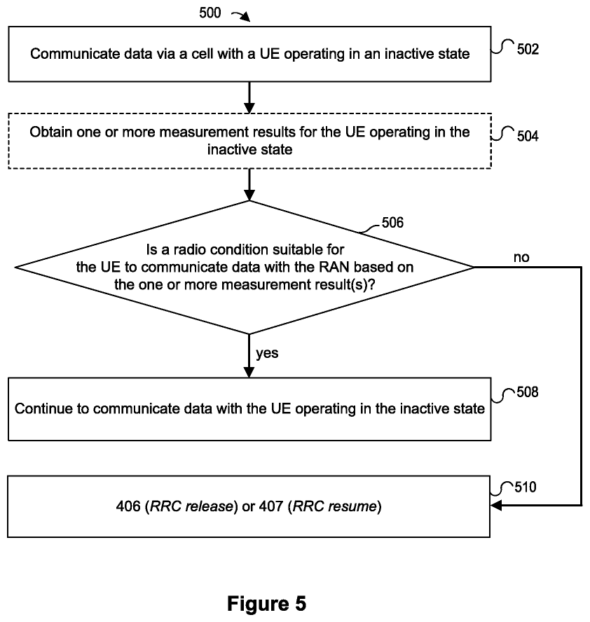

Turning to FIG. 5, a RAN (e.g., RAN 105, base station 104/106, CU 172, CU-CP 172A) can implement an example method 500 to determine whether to communicate with a UE (e.g., the UE 102) in an inactive state or connected state, similar to example methods 400A and 400B.

The method 500 begins at block 502, where the RAN communicates data via a cell with the UE operating in an inactive state (e.g., events 316, 318, 326, 328). At block 504, the RAN receives one or more measurement results from the UE operating in an inactive state. In some implementations, the RAN receives the one or more measurement results via the cell from the UE operating in the inactive state (e.g., events 320). Alternatively, the RAN can obtain the one or more measurement result by measuring uplink transmissions transmitted by the UE via the cell. The uplink transmissions include reference signals (e.g., demodulation reference signals and/or sounding reference signals), physical uplink shared channel (PUSCH) transmissions, and/or PUCCH transmission. At block 506, the RAN determines whether a radio condition (e.g., any of the signal or radio link quality conditions discussed herein) is suitable for the UE to communicate data with the RAN based on the measurement result(s). If the RAN determines that a radio condition is suitable for the UE to communicate data with the RAN based on the measurement result(s), the flow proceeds to block 508. At block 508, the RAN continues to communicate data with the UE operating in the inactive state (e.g., events 318, 328). Otherwise, if the RAN determines that a radio condition is not suitable for the UE to communicate data with the RAN based on the measurement result(s), the flow proceeds to block 510. At block 510, the RAN transmits either a RRC release message or a RRC resume message to the UE to transition the UE to as described for the block 406 or 407 respectively (see e.g., event 322, 323, 332).

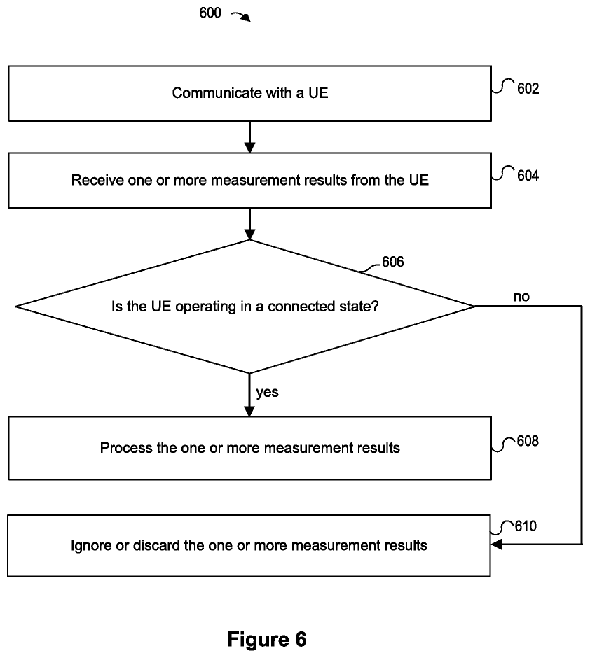

Turning to FIG. 6, a RAN (e.g., RAN 105, base station 104/106, CU 172, CU-CP 172A) can implement an example method 600 to determine to process or ignore a measurement result received from a UE (e.g., the UE 102).

The method 600 begins at block 602, where the RAN communicates with a UE (e.g., events 316, 318, 326, 328). At block 604, the RAN receives one or more measurement results from the UE (e.g., event 320, 330). At block 606, the RAN determines whether the UE is operating in a connected state. If the RAN determines that the UE is operating in a connected state, the flow proceeds to block 608. At block 608, the RAN processes the one or more measurement results. Otherwise, if the RAN determines that the UE is not operating in a connected state, the flow proceeds to block 610. At block 610, the RAN ignores or discards the one or more measurement results. In some implementations, the RAN may not implement a complicated measurement management function to handle measurement results received from UEs operating in the inactive state. Instead, the RAN can implement a simple measurement management function by simply ignoring or discarding measurement results received from UEs operating in the inactive state.

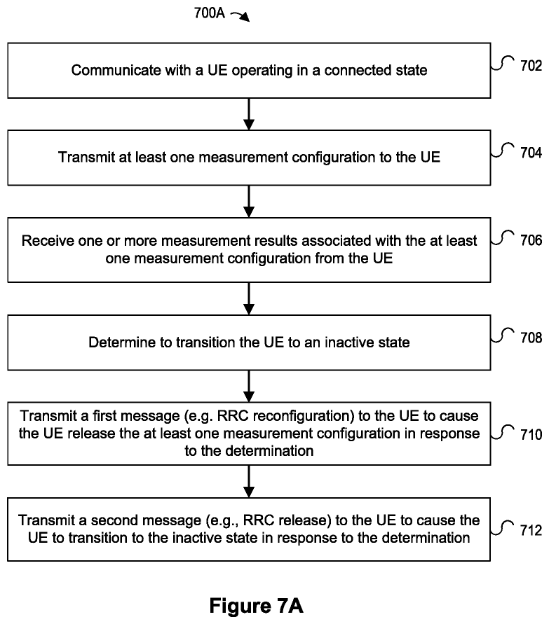

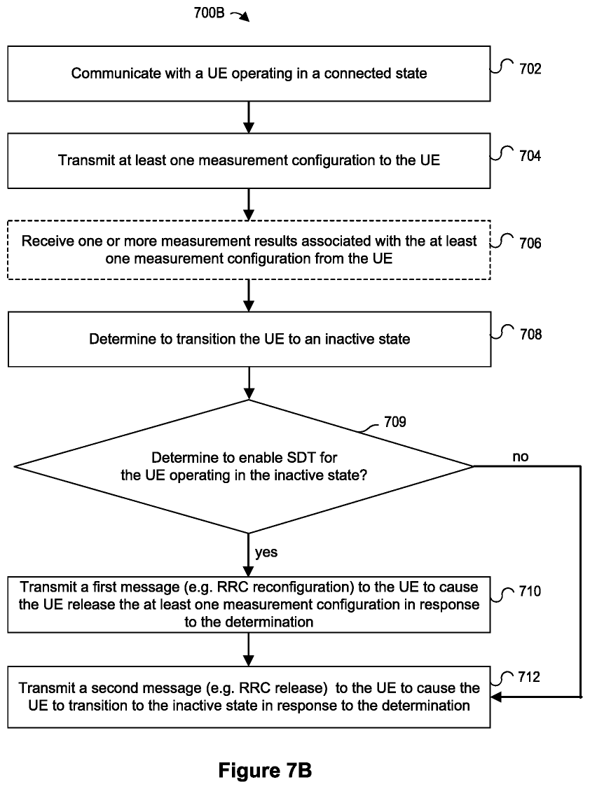

Turning to FIG. 7A, a RAN (e.g., RAN 105, base station 104/106, CU 172, CU-CP 172A) can implement an example method 700A to determine how to manage a measurement configuration for a UE (e.g., the UE 102) when determining to transition the UE to the inactive state. The method 700A begins at block 702, where the RAN communicates with the UE operating in a connected state (e.g., events 304, 329). At block 704, the RAN transmits at least one measurement configuration to the UE. At block 706, the RAN receives one or more measurement results associated with the at least one measurement configuration from the UE (e.g., events 327, 330). At block 708, the RAN determines to transition the UE to an inactive state. At block 710, the RAN transmits a first message to the UE to cause the UE to release the at least one measurement configuration in response to the determination at block 708. At block 712, the RAN transmits a second message to the UE to cause the UE to transition to the inactive state in response to the determination at block 708 (e.g., events 306, 322, 332). In some implementations, the first message is a RRC reconfiguration message, and the second message is a RRC release message.

FIG. 7B is a flow diagram of an example method 700B, which is similar to the method 700A but with the differences described below.

At block 709, the RAN determines whether to enable SDT for the UE operating in the inactive state. If the RAN determines to enable SDT for the UE operating in the inactive state, the flow proceeds to block 710 (with the transmission at block 710 being in response to the determination at block 709). Otherwise, if the RAN determines not to enable SDT for the UE operating in the inactive state, the flow proceeds to block 712 (with the transmission at block 712 being in response to the determination at block 708). The flow proceeds to block 712 from block 710 as well as from block 709.

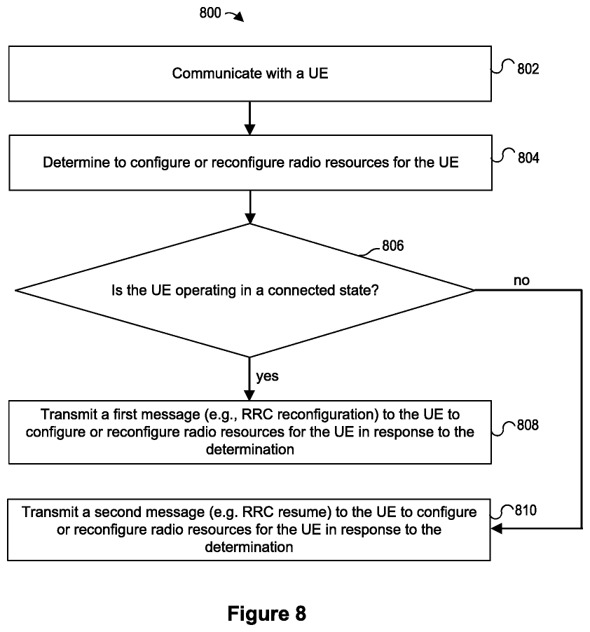

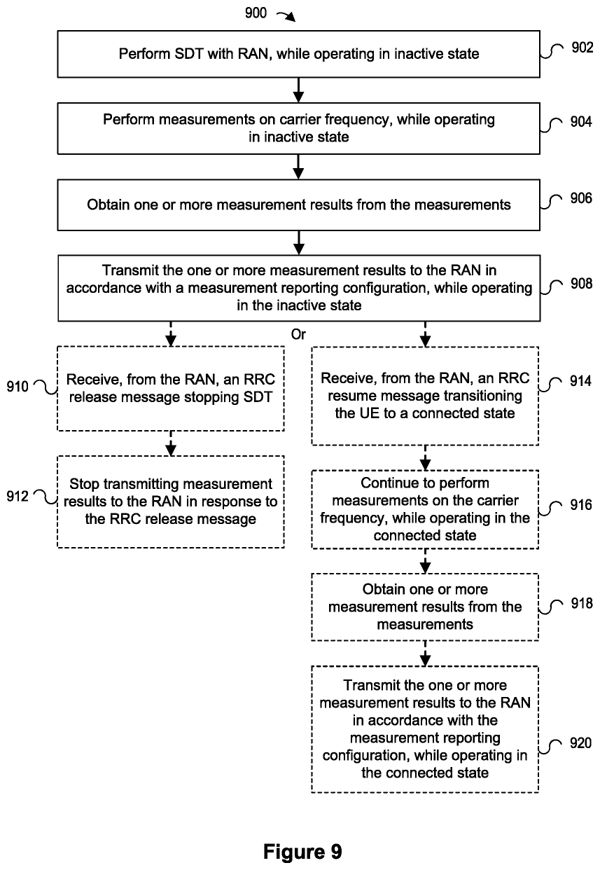

Turning to FIG. 8, a RAN (e.g., RAN 105, base station 104/106, CU 172, CU-CP 172A) can implement an example method 800 to determine how to reconfigure radio resources for a UE (e.g., the UE 102) depending on whether the UE is operating in a connected state.

The method 800 begins at block 802, where the RAN communicates with a UE. At block 804, the RAN determines to configure or reconfigure radio resources for the UE. At block 806, the RAN determines whether the UE is operating in a connected state. If the RAN determines the UE is operating in a connected state, the flow proceeds to block 808. At block 808, the RAN transmits a first message to the UE to configure or reconfigure radio resources for the UE in response to the determination at block 806. Otherwise, if the RAN determines the UE is operating in an inactive state, the flow proceeds to block 810. At block 810, the RAN transmits a second message to the UE to configure or reconfigure radio resources for the UE in response to the determination at block 806.

In some implementations, the first message is an RRC reconfiguration message, and the RAN can receive an RRC reconfiguration complete message from the UE in response to the RRC reconfiguration message. In some implementations, the second message is an RRC resume message (e.g., event 323), and the RAN can receive an RRC resume complete message from the UE in response to the RRC resume message. In other implementations, the second message is an RRC release message (e.g., events 306, 322, 332).

In some implementations, the radio resources can include radio bearer(s) (e.g., SRB, DRB or a multicast radio bearer (MRB)). For example, the RAN can determine to configure (e.g., add) a radio bearer (e.g., SRB, DRB or MRB) for the UE. In other implementations, the radio resources can include radio resources for operation of PDCP, RLC, MAC, and/or PHY protocols. In yet other implementations, the radio resources can include measurement configuration(s).

In cases where the UE is operating in the connected state, the RAN can include the configuration parameters for the radio resources in the first message. In cases where the UE is operating in the inactive state, the RAN can include the configuration parameters in the second message. The RAN applies the configuration parameters to communicate with the UE after transmitting the first message or second message to the UE, receiving an acknowledgement for the first message or second message from the UE, or receiving a response message (e.g., the RRC reconfiguration complete message or the RRC resume complete message) from the UE in response to the first message or the second message.

Turning to FIG. 9, a UE (e.g., the UE 102) can implement an example method 900 to transmit a measurement report to a RAN (e.g., the RAN 105), while communicating data with the RAN in the inactive state.

The method 900 begins at block 902, where the UE performs SDT with a RAN (i.e., the UE has an SDT session with the RAN), while operating in an inactive state (e.g., events 316, 318, 326, 328). At block 904, the UE performs measurements on a carrier frequency, while operating in the inactive state. At block 906, the UE obtains one or more measurement results from the measurements. At block 908, the UE transmits the one or more measurement results to the RAN in accordance with a measurement reporting configuration, while operating in the inactive state (e.g., event 320, 330). After block 908, the flow optionally proceeds to either block 910 or 914. At block 910, the UE receives, from the RAN, an RRC release message transitioning the UE to the inactive state (e.g., events 322, 332). At block 912, the UE stops transmitting measurement results to the RAN in response to the RRC release message. At block 914, the UE receives, from the RAN, an RRC resume message transitioning the UE to a connected state (e.g., event 323). At block 916, the UE continues to perform measurements on the carrier frequency, while operating in the connected state. At block 918, the UE obtains one or more measurement results from the measurements. At block 920, the UE transmits the one or more measurement results to the RAN in accordance with the measurement reporting configuration, while operating in the connected state (e.g., event 331).

In some implementations, the UE can (start to) perform measurements on an additional carrier frequency in response to the RRC resume message, at block 916. The UE 102 can do so if the UE receives a measurement configuration configuring the additional carrier frequency before performing the SDT, or if the RRC resume message includes the measurement configuration. In such implementations, the UE in the connected state can obtain one or more measurement results from the measurements and transmit the one or more measurement results to the RAN.

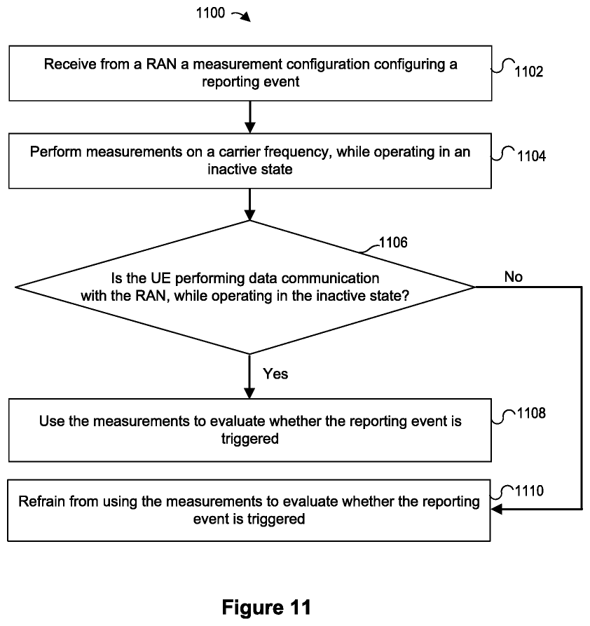

Turning to FIG. 10, a UE (e.g., the UE 102) can implement an example method 1000 to determine whether to transmit a measurement report to a RAN (e.g., the RAN 105), while operating in the inactive state.

The method 1000 begins at block 1002, where the UE operates in an inactive state with a RAN (see e.g., event 308, 338). At block 1004, the UE performs measurements on a carrier frequency, while operating in the inactive state. At block 1006, the UE determines whether the UE is performing data communication with the RAN while operating in the inactive state (i.e., the UE determines whether the UE has an SDT session with the RAN). If the UE is performing data communication with the RAN while operating in the inactive state, the flow proceeds to block 1008. At block 1008, the UE transmits to the RAN a measurement report including a measurement result derived from the measurements. Otherwise, if the UE is not performing data communication with the RAN while operating in the inactive state (i.e., the UE has no SDT session with the RAN), the flow proceeds to block 1010. At block 1010, the UE refrains from transmitting a measurement report to the RAN. By refraining from transmitting a measurement report, the UE neither initiates SDT nor initiates an RRC resume procedure to transition to a connected state, which saves the UE battery power.

Turning to FIG. 11, a UE (e.g., the UE 102) can implement an example method 1100 to determine whether to evaluate a reporting event configured by a RAN (e.g., the RAN 105), while operating in an inactive state.

The method 1100 begins at block 1102, where the UE receives from a RAN a measurement configuration specifying/configuring a reporting event. At block 1104, the UE performs measurements on a carrier frequency, while operating in an inactive state. At block 1106, the UE determines whether the UE is performing data communication (i.e., SDT) with the RAN while operating in the inactive state (i.e., the UE determines whether the UE has a SDT session with the RAN). If the UE is performing data communication while operating in the inactive state, the flow proceeds to block 1108. At block 1108, the UE uses the measurements (or measurement result(s) obtain from the measurements) to evaluate whether the reporting event is triggered. Otherwise, if the UE is not performing data communication while operating in the inactive state (i.e., the UE has no SDT session with the RAN), the flow proceeds to block 1110. At block 1110, the UE refrains from using the measurements (or measurement result(s) obtain from the measurements) to evaluate whether the reporting event is triggered.

In some implementations, the reporting event can be event A1, event A2, event A3, event A4, event A5, or event I1, as described below or described in 3GPP specification 38.331 (e.g., v16.7.0).
Event A1: a serving cell becomes better than a threshold
Event A2: a serving cell becomes worse than a threshold
Event A3: a neighbor cell becomes better than a serving cell by a particular (offset) amount
Event A4: a neighbor cell becomes better than a threshold
Event A5: a serving cell becomes worse than threshold1 and a neighbor cell becomes better than threshold2
Event I1: Interference becomes higher than threshold

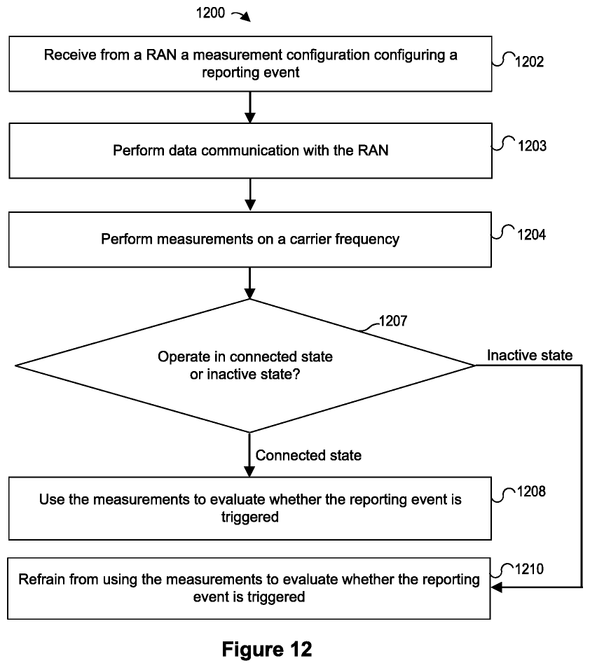

Turning to FIG. 12, a UE (e.g., the UE 102) can implement an example method 1200 to determine whether to evaluate a reporting event configured by a RAN (e.g., the RAN 105), while operating in a connected state or an inactive state.

The method 1200 begins at block 1202, where the UE receives from a RAN a measurement configuration specifying/configuring a reporting event. At block 1203, the UE performs data communication with the RAN (e.g., event 304, 316, 318, 326, 328, 329, 340). At block 1204, the UE performs measurements on a carrier frequency. At block 1207, the UE determines whether the UE operates in a connected state or an inactive state. If the UE operates in the connected state, the flow proceeds to block 1208. At block 1208, the UE uses the measurements to evaluate whether the reporting event is triggered, similar to the block 1108. Otherwise, if the UE operates in the inactive state, the flow proceeds to block 1210. At block 1210, the UE refrains from using the measurements to evaluate whether the reporting event is triggered, similar to the block 1110. Examples of the reporting event are as described for FIG. 11. Thus, for multiple instances/iterations of the method 1200 at different times, the UE can transmit a measurement report based on the measurement(s) corresponding to times or time periods when the UE is in a connected state, but refrains from transmitting any measurement report based on the measurements that correspond to times or time periods when the UE is in an inactive state with SDT enabled.

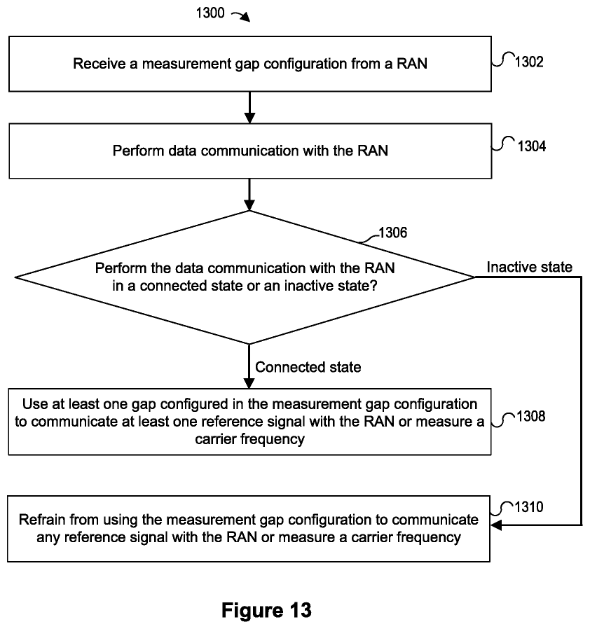

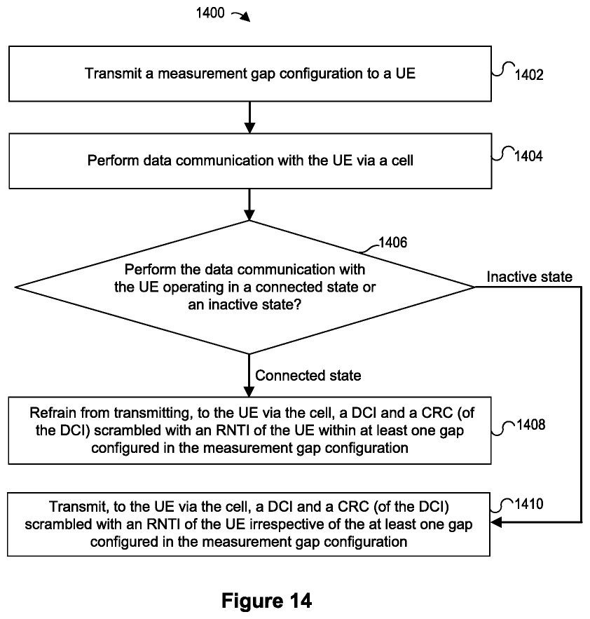

Turning to FIG. 13, a UE (e.g., the UE 102) can implement an example method 1300 to determine whether to apply a measurement gap configuration configured by a RAN (e.g., the RAN 105), while operating in a connected state or an inactive state.

The method 1300 begins at block 1302, where the UE receives a measurement gap configuration from a RAN. At block 1304, the UE performs data communication with the RAN (e.g., event 304, 316, 318, 326, 328, 329, 340). At block 1306, the UE determines whether the UE performs the data communication with the RAN in a connected state or an inactive state. In cases where the UE performs the data communication in the connected state, the flow proceeds to block 1308. At block 1308, the UE uses at least one measurement gap specified/configured in the measurement gap configuration to communicate at least one reference signal or measure a carrier frequency, during the data communication. Otherwise, in cases where the UE performs the data communication with the RAN in the inactive state, the flow proceeds to block 1310. At block 1310, the UE refrains from using the measurement gap configuration (i.e., the at least one measurement gap specified/configured in the measurement gap configuration) to communicate any reference signal or measure a carrier frequency, during the data communication.

In some implementations, the UE at block 1308 can transmit the at least one reference signal to the RAN within one, some, or all of the at least one measurement gap. For example, the at least one reference signal can include a positioning reference signal (PRS) or a sounding reference signal (SRS). In other implementations, the UE at block 1308 can receive the at least one reference signal from the RAN within one, some, or all of the at least one measurement gap. For example, the at least one reference signal includes a synchronization signal block (SSB), a positioning reference signal (PRS) or a channel state information reference signal (CSI-RS).

Turning to FIG. 14, a RAN (e.g., RAN 105, base station 104/106, CU 172, CU-CP 172A) can implement an example method 1400 to determine whether to apply a measurement gap configuration for a UE (e.g., UE 102), depending on whether the UE operates in a connected state or an inactive state.

The method 1400 begins at block 1402, where the RAN transmits a measurement gap configuration to the UE. At block 1404, the RAN performs data communication with the UE via a cell (e.g., event 304, 316, 318, 326, 328, 329, 340). At block 1406, the RAN determines whether the RAN performs the data communication with the UE operating in a connected state or an inactive state. In cases where the RAN performs the data communication with the UE operating in the connected state, the flow proceeds to block 1408. At block 1408, the RAN refrains from transmitting, to the UE via the cell, a DCI and a CRC (of the DCI) scrambled with a RNTI of the UE within at least one measurement gap configured in (specified by) the measurement gap configuration. Otherwise, in cases where the RAN performs the data communication with the UE in the inactive state (i.e., SDT), the flow proceeds to block 1410. At block 1410, the RAN transmits, to the UE via the cell a DCI and a CRC (of the DCI) scrambled with a RNTI of the UE irrespective of the at least one measurement gap (i.e., without avoiding the measurement gap, such that the DCI transmission could occur within the at least one measurement gap). In some implementations, the RNTI is a cell RNTI (C-RNTI).

The following list of examples reflects a variety of the implementations explicitly contemplated by the present disclosure:

Example 1. A method, implemented by a UE, of managing measurement reporting, the method comprising: performing a plurality of measurements on a carrier frequency used for communication with a RAN, the plurality of measurements including (i) first measurements corresponding to times when the UE is in a connected state, and (ii) second measurements corresponding to times when the UE is in an inactive state with SDT enabled; transmitting a first measurement report based on at least one of the first measurements to the RAN; and refraining from transmitting any measurement report based on the second measurements.

Example 2. The method of example 1, further comprising: using the at least one of the first measurements to determine that a first reporting event is triggered, wherein transmitting the first measurement report is in response to determining that the first reporting event is triggered, and wherein refraining from transmitting any measurement report based on the second measurements includes refraining from using any of the second measurements to evaluate whether a reporting event is triggered.

Example 3. The method of example 2, further comprising: before performing the plurality of measurements and while the UE is in the connected state, receiving, from the RAN, a measurement configuration specifying the first reporting event.

Example 4. The method of example 1 or 2, further comprising: before performing the plurality of measurements and while the UE is in the connected state, receiving, from the RAN, a measurement configuration specifying a measurement gap; when the UE is in the connected state, using the measurement gap to facilitate or perform one or more measurements; and when the UE is in the inactive state with SDT enabled, refraining from using the measurement gap to facilitate or perform any measurements.

Example 5. The method of example 4, wherein: using the measurement gap to facilitate or perform one or more measurements includes communicating at least one reference signal with the RAN during the measurement gap; and refraining from using the measurement gap to facilitate or perform any measurements includes refraining from communicating any reference signal with the RAN during the measurement gap.

Example 6. The method of example 5, wherein communicating the at least one reference signal includes transmitting a positioning reference signal (PRS) or a sounding reference signal (SRS) to the RAN during the measurement gap.

Example 7. The method of example 5, wherein communicating the at least one reference signal includes receiving a SSB, a PRS, or a CSI-RS from the RAN during the measurement gap.

Example 8. The method of example 4, wherein: using the measurement gap to facilitate or perform one or more measurements includes performing, during the measurement gap, at least one measurement on a carrier frequency used to communicate with the RAN; and refraining from using the measurement gap to facilitate or perform any measurements includes refraining from performing any measurement on the carrier frequency during the measurement gap.

Example 9. A method performed by a UE, of managing measurement procedures, the method comprising: receiving, from a RAN while the UE is in a connected state, a measurement configuration specifying a measurement gap; when the UE is in the connected state, using the measurement gap to facilitate or perform one or more measurements; and when the UE is in an inactive state with SDT enabled, refraining from using the measurement gap to facilitate or perform any measurements.

Example 10. The method of example 9, wherein: using the measurement gap to facilitate or perform one or more measurements includes communicating at least one reference signal with the RAN during the measurement gap; and refraining from using the measurement gap to facilitate or perform any measurements includes refraining from communicating any reference signal with the RAN during the measurement gap.

Example 11. The method of example 10, wherein communicating the at least one reference signal includes transmitting a PRS or a SRS during the measurement gap.

Example 12. The method of example 10, wherein communicating the at least one reference signal includes receiving from the RAN a SSB, a PRS, or a CSI-RS during the measurement gap.

Example 13. The method of example 9, wherein: using the measurement gap to facilitate or perform one or more measurements includes performing, during the measurement gap, at least one measurement on a carrier frequency used to communicate with the RAN; and refraining from using the measurement gap to facilitate or perform any measurements includes refraining from performing any measurement on the carrier frequency during the measurement gap.

Example 14. A UE comprising processing hardware and configured to perform the method of any one of examples 1-13.

Example 15. A method, performed by one or more nodes of a RAN, of managing measurement configurations, the method comprising: transmitting at least one measurement configuration to a UE in a connected state; determining to transition the UE to an inactive state; after the determining, causing the UE to release the at least one measurement configuration; and causing, in response to the determining, the UE to transition to the inactive state.

Example 16. The method of example 15, wherein: causing the UE to release the at least one measurement configuration includes transmitting to the UE a first message that causes the UE to release the at least one measurement configuration; and causing the UE to transition to the inactive state includes transmitting to the UE a second message that causes the UE to transition to the inactive state.

Example 17. The method of example 16, wherein the first message is an RRC reconfiguration message, and the second message is an RRC release message.

Example 18. The method of any one of examples 15-17, wherein causing the UE to release the at least one measurement configuration is in response to the determining.

Example 19. The method of any one of examples 15-17, further comprising: determining to enable SDT for the UE, wherein causing the UE to release the at least one measurement configuration is in response to determining to enable SDT for the UE.

Example 20. A method, performed by one or more nodes of a RAN, of configuring or reconfiguring a UE, the method comprising: communicating data with the UE while the UE is in an inactive state with SDT enabled; determining to configure or reconfigure one or more radio resources for the UE while the UE is in the inactive state with SDT enabled; and in response to the determining, transmitting, while the UE is in the inactive state with SDT enabled, a message to the UE to configure or reconfigure the one or more radio resources for the UE.

Example 21. The method of example 20, wherein the message is an RRC resume message.

Example 22. The method of example 20, wherein the message is an RRC release message.

Example 23. The method of example 22, further comprising: detecting data inactivity for the UE, wherein the determining is in response to the detecting.

Example 24. The method of example 22, further comprising: obtaining one or more measurement results, wherein the determining is in response to the one or more measurement results.

Example 25. A method performed by one or more nodes of a RAN, of managing measurement procedures, the method comprising: transmitting, to a UE in a connected state, a measurement configuration specifying a measurement gap; determining that the UE is in an inactive state with SDT enabled; and in response to the determining, transmitting a DCI to the UE irrespective of the measurement gap.

Example 26. The method of example 25, comprising: in response to the determining, transmitting the DCI, and a CRC scrambled with an RNTI of the UE, to the UE irrespective of the measurement gap.

Example 27. One or more nodes of a RAN comprising processing hardware and configured to perform the method of any one of examples 15-26.

Example 28. A method, performed by one or more nodes of a RAN, for managing measurement reporting, the method comprising: communicating data with a UE in an inactive state with SDT enabled; and while the UE is in the inactive state with SDT enabled, obtaining one or more measurement results for the UE.

Example 29. The method of example 28, wherein the obtaining includes receiving from the UE a measurement report that includes the one or more measurement results.

Example 30. The method of example 28, wherein the obtaining includes performing one or more measurements to obtain the one or more measurement results.

Example 31. The method of any one of examples 28-30, further comprising: based on the one or more measurement results, transmitting an RRC release message to the UE.

Example 32. The method of example 31, wherein communicating data with the UE occurs via a first cell of the RAN, and wherein the method further comprises: after transmitting the RRC release message, communicating data with the UE via a second cell of the RAN is in an inactive state.

Example 33. The method of any one of examples 28-30, further comprising: based on the one or more measurement results, transmitting an RRC resume message to the UE.

Example 34. The method of example 33, further comprising: after transmitting the RRC resume message, communicating data with the UE while the UE is in a connected state.

Example 35. The method of any one of examples 28-30, wherein communicating data with the UE occurs via a first cell of the RAN, and wherein the method further comprises: based on the one or more measurement results, continuing to communicate data with the UE via the first cell while the UE is in the inactive state with SDT enabled.

Example 36. One or more nodes of a RAN comprising processing hardware and configured to perform the method of any one of examples 28-35.

Example 37. A method, performed by a UE, for handling measurement reporting, the method comprising: communicating data with a RAN while the UE is in an inactive state with SDT enabled; performing, while the UE is in the inactive state with SDT enabled, a plurality of measurements on a carrier frequency used for communication with the RAN; and transmitting, while the UE is in the inactive state with SDT enabled, a measurement report to the RAN based on at least one of the plurality of measurements.

Example 38. The method of example 37, further comprising: after the transmitting, receiving an RRC release message from the RAN.

Example 39. The method of example 38, wherein communicating data with the RAN occurs via a first cell of the RAN, and wherein the method further comprises: after receiving the RRC release message, communicating data with the RAN via a second cell of the RAN while the UE is in an inactive state.

Example 40. The method of example 37, further comprising: after the transmitting, receiving an RRC resume message from the RAN.

Example 41. The method of example 40, further comprising: after receiving the RRC resume message, communicating data with the RAN while the UE is in a connected state.

Example 42. The method of example 37, wherein communicating data with the RAN occurs via a first cell of the RAN, and wherein the method further comprises: after the transmitting, continuing to communicate data with the RAN via the first cell while the UE is in the inactive state with SDT enabled.

Example 43. The method of example 37, further comprising: before communicating data with the RAN while the UE is in the inactive state with SDT enabled, receiving a measurement reporting configuration from the RAN while the UE is in a connected state, wherein the measurement report is a first measurement report in accordance with the measurement reporting configuration.

Example 44. The method of example 43, further comprising: after the transmitting, receiving an RRC resume message from the RAN; after receiving the RRC resume message, performing a plurality of additional measurements on the carrier frequency while the UE is in the connected state; and transmitting, while the UE is in the connected state, a second measurement report to the RAN based on at least one of the plurality of additional measurements, the second measurement report being in accordance with the measurement reporting configuration.

Example 45. A method, performed by a UE, for handling measurement reporting, the method comprising: performing a plurality of measurements on a carrier frequency used for communication with a RAN, the plurality of measurements including (i) first measurements corresponding to times when the UE is in an inactive state with SDT enabled, and (ii) second measurements corresponding to times when the UE is in an inactive state without SDT enabled; transmitting a first measurement report based on at least one of the first measurements to the RAN; and refraining from transmitting any measurement report based on the second measurements.

Example 46. The method of example 45, wherein: transmitting the first measurement report based on the at least one of the first measurements includes using the at least one of the first measurements to determine that a reporting event is triggered; and refraining from transmitting any measurement report based on the second measurements includes refraining from using any of the second measurements to evaluate whether a reporting event is triggered.

Example 47. A UE comprising processing hardware and configured to perform the method of any one of examples 37-46.

The following description may be applied to the description above.

In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. In some implementations, “small data transmission” can be replaced by “early data transmission (EDT)” and “SDT” can be replaced by “EDT”, and vice versa. In some implementations, “small data transmission” can be replaced by “small data communication”, and vice versa. In some implementations, “communicating data via RB(s)” can be replaced by “communicate data associated to RB(s)” or “communicate data on RB(s),” and “communicate” can be replaced by “transmit,” “receive,” or “transmit and receive.”

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method, performed by one or more nodes of a radio access network (RAN), of configuring or reconfiguring a user equipment (UE), the method comprising:
communicating data with the UE while the UE is in an inactive state and configured for small data transmission (SDT) operation;
determining to configure or reconfigure one or more radio resources for the UE while the UE is in the inactive state and configured for SDT operation; and
in response to the determining, transmitting, while the UE is in the inactive state and configured for SDT operation, a radio resource control (RRC) release message to the UE to configure or reconfigure the one or more radio resources for the UE.

2.-3. (canceled)

4. The method of claim 1, further comprising:
detecting data inactivity for the UE,
wherein the determining is in response to the detecting.

5. The method of claim 1, further comprising:
obtaining one or more measurement results,
wherein the determining is in response to the one or more measurement results.

6. One or more nodes of a radio access network (RAN), the one or more nodes comprising processing hardware and being configured to:
communicate data with a user equipment (UE) while the UE is in an inactive state and configured for small data transmission (SDT) operation;
determine to configure or reconfigure one or more radio resources for the UE while the UE is in the inactive state and configured for SDT operation; and
in response to the determining, transmit, while the UE is in the inactive state and configured for SDT operation, a radio resource control (RRC) release message to the UE to configure or reconfigure the one or more radio resources for the UE.

7. A method, performed by a user equipment (UE), of managing measurement reporting, the method comprising:
performing a plurality of measurements on a carrier frequency used for communication with a radio access network (RAN), the plurality of measurements including (i) first measurements corresponding to times when the UE is in a connected state, and (ii) second measurements corresponding to times when the UE is in an inactive state and configured for small data transmission (SDT) operation;
transmitting a first measurement report based on at least one of the first measurements to the RAN; and
refraining from transmitting any measurement report based on the second measurements.

8. The method of claim 7, further comprising:
using the at least one of the first measurements to determine that a first reporting event is triggered,
wherein transmitting the first measurement report is in response to determining that the first reporting event is triggered, and
wherein refraining from transmitting any measurement report based on the second measurements includes refraining from using any of the second measurements to evaluate whether a reporting event is triggered.

9. The method of claim 8, further comprising:
before performing the plurality of measurements and while the UE is in the connected state, receiving, from the RAN, a measurement configuration specifying the first reporting event.

10. The method of claim 7, further comprising:
before performing the plurality of measurements and while the UE is in the connected state, receiving, from the RAN, a measurement configuration specifying a measurement gap;
when the UE is in the connected state, using the measurement gap to facilitate or perform one or more measurements; and
when the UE is in the inactive state and configured for SDT operation, refraining from using the measurement gap to facilitate or perform any measurements.

11. The method of claim 10, wherein:
using the measurement gap to facilitate or perform one or more measurements includes communicating at least one reference signal with the RAN during the measurement gap; and
refraining from using the measurement gap to facilitate or perform any measurements includes refraining from communicating any reference signal with the RAN during the measurement gap.

12. The method of claim 11, wherein communicating the at least one reference signal includes transmitting a positioning reference signal (PRS) or a sounding reference signal (SRS) to the RAN during the measurement gap.

13. The method of claim 11, wherein communicating the at least one reference signal includes receiving a synchronization signal block (SSB), a positioning reference signal (PRS), or a channel state information reference signal (CSI-RS) from the RAN during the measurement gap.

14. The method of claim 10, wherein:
using the measurement gap to facilitate or perform one or more measurements includes performing, during the measurement gap, at least one measurement on a carrier frequency used to communicate with the RAN; and
refraining from using the measurement gap to facilitate or perform any measurements includes refraining from performing any measurement on the carrier frequency during the measurement gap.

15. (canceled)

16. The one or more nodes of claim 6, wherein the one or more nodes are further configured to:
detect data inactivity for the UE,
wherein the determining is in response to the detecting.

17. The one or more nodes of claim 6, wherein the one or more nodes are further configured to:
obtain one or more measurement results,
wherein the determining is in response to the one or more measurement results.
